(19) United States
(12) Patent Application Publication
(10) Pub. No.: US 2026/0213705 A1
(43) Pub. Date: Jul. 23, 2026

(54) Dual-Function Electrodynamic Retrofit Film (ERF) for Solar Panels

(71) Applicant: 1000892670 Ontario Inc (Swish Solar), Kitchener (CA)

(72) Inventors: Amirhossein Boreiri, Kitchener (CA); Miswar Akhtar Syed, Kitchener (CA)

(73) Assignee: 1000892670 Ontario Inc (Swish Solar), Kitchener (CA)

(21) Appl. No.: 19/453,003

(22) Filed: Jan. 20, 2026

Related U.S. Application Data
(60) Provisional application No. 63/747,185, filed on Jan. 20, 2025.

(51) Int. Cl. H02S 40/12; H02S 40/32

(52) U.S. Cl. CPC H02S 40/12; H02S 40/32

(57) ABSTRACT

A dual-function electrodynamic retrofit film (DFERF) is disclosed for maintaining solar panel efficiency by removing accumulated dust, debris, snow, or ice. The DFERF comprises a transparent film with embedded nanomaterial electrodes (NMEs) that can operate in two modes: an electrodynamic dust-removal mode and a resistive heating snow-removal mode. In the dust removal mode, a controlled high voltage traveling wave is applied across a first subset of electrodes to electrostatically charge and repel dust particles (Coulombic repulsion, where force F=qE, with q being particle charge and E the electric field). In the snow removal mode, a second subset of electrodes is energized with electrical current to generate heat, melting snow and ice. The DFERF film is thin, transparent, and retrofittable or integrable into solar panels without blocking light. A power and control unit (PCU) with sensors automatically switches between modes based on environmental conditions.

### CROSS REFERENCE TO RELATED APPLICATION

This application claims the benefit under 35 U.S.C. § 119 (e) of U.S. Provisional Application No. 63/747,185 entitled “DUAL-FUNCTION SELF-CLEANING DEVICE FOR DUST OR DEBRIS AND SNOW OR ICE REMOVAL FROM SOLAR PANELS AND METHODS OF REMOVING DUST OR DEBRIS AND SNOW OR ICE FROM SOLAR PANELS” filed on Jan. 20, 2025, which is incorporated herein by reference.

### TECHNICAL FIELD

The present disclosure relates to devices and methods for removing dust or debris and snow or ice from solar panels. More particularly, the disclosure relates to a dual-function electrodynamic device for removing dust or debris and snow or ice from solar panels or similar surfaces.

### BACKGROUND

Solar panels are highly susceptible to environmental fouling from dust, sand, snow, and ice, which can significantly degrade performance. In arid and dusty regions, accumulation of dust and sand on panel surfaces blocks incident sunlight and can reduce energy output by as much as 60%. In cold climates, snow and ice buildup can severely inhibit and halt energy production, often resulting in near-zero output while panels remain covered. Regular cleaning is therefore required to maintain photovoltaic (PV) efficiency across diverse environments.

A few dust-removal methods in prior art typically rely on water-based washing or mechanical cleaning. Manual washing and robotic cleaning systems consume large quantities of water and need labor, infrastructure, and ongoing maintenance. Dry mechanical methods, such as brushing or air blowing, can abrade panel surfaces over time. Passive anti-soiling coatings, including hydrophobic or hydrophilic treatments, reduce dust adhesion but degrade under harsh environmental conditions and still depend on wind or rain for effectiveness. For snow removal, existing approaches include manual shoveling, heated air or water systems, surface-applied heating strips, and mechanized clearing devices. These solutions are labor-intensive, consume substantial power, introduce opaque or shading elements, create thermal stress hotspots, risk damaging panel glass, and are impractical for large-scale installations. Many existing solutions address either dust or snow, but not both, and often introduce additional cost, complexity, or resource consumption.

The global transition toward renewable energy has accelerated the deployment of solar energy systems in diverse climates, including dusty desert regions and snow-prone cold regions. While solar panel efficiency and cost-effectiveness have improved significantly, environmental contamination remains a huge limitation. In regions such as the Middle East, North Africa, and parts of Africa, frequent dust storms and persistent particulate deposition reduce PV output. Also, in cold regions such as Canada, snow accumulation remains a dominant seasonal constraint on solar energy generation. As a result, solar panels need frequent cleaning to maintain acceptable performance year-round.

Prior art solutions include water-based sprinkler systems, robotic cleaners, and mechanized snow-removal devices. These approaches suffer from high operational cost, dependence on water or consumables, mechanical complexity, scalability limitations, and maintenance burden. Frequent mechanical or water-based cleaning can also shorten panel lifespan due to abrasion or mineral residue. In remote or off-grid installations, such solutions are often impractical or infeasible.

Electrodynamic screens (EDS) have been proposed for dust removal, employing nanomaterial electrodes energized by high voltage alternating signals to generate electrostatic fields that charge and repel dust particles. EDS-based systems need minimum power, no water, and no moving parts, and can maintain high optical transparency. However, practical implementation on deployed solar panels presents challenges, including integration of high-voltage power generation, control electronics, sensing, weatherproofing, and autonomous operation. Existing EDS implementations are typically laboratory-based or rely on external components and do not provide a compact, integrated, retrofit-compatible solution for field deployment.

Accordingly, there remains a need for a unified, sustainable, and automated solution capable of addressing both dust and snow accumulation on solar panels. Such a solution should operate year-round, consume minimal power, avoid shading or mechanical wear, require no water or manual intervention, integrate seamlessly with existing solar panel designs (including retrofits), and enable safe, selective switching between dust-clearing and snow-removal modes. The present disclosure addresses these needs by providing a dual-function self-cleaning system that integrates electrodynamic dust removal and resistive snow-melting capabilities into a single, compact device.

### SUMMARY

In one aspect, an apparatus is provided for dust or debris removal and snow or ice removal on a solar panel including a top surface, the solar panel further including a plurality of active elements disposed on the top surface, with respective gaps therebetween, in a plurality of columns disposed, with respective bus bars therebetween, in a plurality of solar cells with respective fingers therebetween. The apparatus includes a dual-function electrodynamic retrofit film (DFERF) including nanomaterial electrodes (NMEs) disposed in one or more layers of the film, a plurality of switches for switching the NMEs from a first functionality for removing the dust or the debris to a second functionality for removing the snow or the ice, a plurality of power generators for providing electricity to the film via the NMEs to enable the first functionality and the second functionality, a plurality of power supply circuits embedded in or traversing the film and connected to the power generators for receiving the electricity provided and further transmitting the electricity to the NMEs, and one or more sensors for measuring conditions, status, or output of the apparatus and determining when to cause the plurality of switches to switch the NMEs on or off and from the first functionality to the second functionality or from the second functionality to the first functionality. In the first functionality, a first subset of the NMEs act as electrostatic force generators for producing a travelling wave to charge and repel dust particles by generating forces large enough to overcome the natural forces acting on the dust particles to effectively repel the dust particles, the force to be generated by the first subset given by F=qE, where q is the charge of the dust particle and where E is the electric field calculated to obtain the force F to overcome the natural forces. In the second functionality, a second subset of the NMEs act as heaters for generating high temperatures to melt the snow or the ice from the solar panel. The DFERF is configured to use a negligible amount of output of the solar panel or an integrated battery to perform the first functionality and the second functionality. The NMEs are disposed in or above the gaps, the bus bars, or the fingers such that the nanomaterial electrodes (NMEs) do not substantially cover the active elements.

In one aspect, the NMEs may be disposed in a single layer of the film, and one or more of the NMEs may be present in both first subset and the second subset. In yet another aspect, the first subset of the NMEs may be disposed in a first layer of the film and the second subset of the NMEs may be disposed in a second layer of the film, and the first layer may be disposed above the second layer. In one aspect, the DFERF may be integrated into the solar panel when the solar panel is manufactured, and at least some of the NMEs may be disposed in the gaps, the bus bars, or the fingers such that the nanomaterial electrodes (NMEs) do not substantially cover the active elements. In yet another aspect, the DFERF may be retrofitted to the solar panel after the solar panel has been manufactured, and the NMEs may be disposed atop the solar panel and aligned with the gaps, the bus bars, or the fingers such that the nanomaterial electrodes (NMEs) do not substantially cover the active elements.

In one aspect, the NMEs may be printed using a conductive ink. The conductive ink may include any one or more of silver nanowires, indium tin oxide, and copper, and the DFERF may include polyethylene terephthalate. The conductive ink may be transparent, and the conductive ink may be applied to the entire top surface. In yet another aspect, the second subset of electrodes may be parallel lines disposed in the gaps. In another aspect, the second subset of electrodes may be a single line in series disposed in the gaps.

In one aspect, the one or more sensors may include any one or more of snow weight detectors, temperature sensors, and power output sensors. The power output sensors may be configured to detect a sudden drop in power output, indicating the accumulation of snow or dust on the solar panel.

In one aspect, a method of dust or debris removal and snow or ice removal on a solar panel is provided, the solar panel including a top surface, the solar panel further including a plurality of active elements disposed on the top surface, with respective gaps therebetween, in a plurality of columns disposed, with respective bus bars therebetween, in a plurality of solar cells with respective fingers therebetween. The method includes providing a dual-function electrodynamic retrofit film (DFERF) including nanomaterial electrodes (NMEs) disposed in one or more layers of the film and a plurality of switches for switching the NMEs from a first functionality for removing the dust or the debris to a second functionality for removing the snow or the ice, providing electricity to the film via the NMEs to enable the first functionality and the second functionality, measuring conditions, status, or output and determining when to cause the plurality of switches to switch the NMEs on or off and from the first functionality to the second functionality or from the second functionality to the first functionality. In the first functionality, a first subset of the NMEs act as electrostatic force generators for producing a travelling wave to charge and repel dust particles by generating forces large enough to overcome the natural forces acting on the dust particles to effectively repel the dust particles, the force to be generated by the first subset given by F=qE, where q is the charge of the dust particle and where E is the electric field calculated to obtain the force F to overcome the natural forces. In the second functionality, a second subset of the NMEs act as heaters for generating high temperatures to melt the snow or the ice from the solar panel. The DFERF is configured to use a negligible amount of output of the solar panel or an integrated battery to perform the first functionality and the second functionality. The NMEs are disposed in or above the gaps, the bus bars, or the fingers such that the nanomaterial electrodes (NMEs) do not substantially cover the active elements.

In one aspect, an apparatus is provided for dust or debris removal and snow or ice removal on a solar panel including a top surface, the solar panel further including a plurality of active elements disposed on the top surface, with respective gaps therebetween, in a plurality of columns disposed, with respective bus bars therebetween, in a plurality of solar cells with respective fingers therebetween, the apparatus including a plurality of upper grooves and a plurality of lower grooves, an upper plurality of nanomaterial electrodes disposed in the upper grooves and a lower plurality of nanomaterial electrodes disposed in the lower grooves, a plurality of switches for switching the nanomaterial electrodes from a first functionality for removing the dust or the debris to a second functionality for removing the snow or the ice, a plurality of power generators for providing electricity to the nanomaterial electrodes to enable the first functionality and the second functionality, a plurality of power supply circuits embedded in or traversing the film and connected to the power generators for receiving the electricity provided thereby and further transmitting the electricity to the nanomaterial electrodes, and one or more sensors for measuring conditions, status, or output of the apparatus and determining when to cause the plurality of switches to switch the nanomaterial electrodes on or off and from the first functionality to the second functionality or from the second functionality to the first functionality.

In one aspect, a method of assembling nanomaterial electrodes on a device for dust or debris removal and snow or ice removal on a solar panel is provided, the solar panel including an upper glass element, the solar panel further including a plurality of active elements disposed on the top surface, with respective gaps therebetween, in a plurality of columns disposed, with respective bus bars therebetween, in a plurality of solar cells with respective fingers therebetween. The method includes creating grooves on the top and bottom surfaces of the upper glass element of the solar panel using laser cutter technology, the grooves being in or above the gaps, the bus bars, or the fingers such that the grooves do not substantially cover the active elements, partially filling the grooves on the top surface with conductive ink to form a first subset of the nanomaterial electrodes configured to act as electrostatic force generators for producing a travelling wave to charge and repel dust particles by generating forces large enough to overcome the natural forces acting on the dust particles to effectively repel the dust particles, partially filling the grooves on the bottom surface with conductive ink to form a second subset of the nanomaterial electrodes configured to act as heaters for generating high temperatures to melt the snow or the ice from the solar panel, coating the grooves and the nanomaterial electrodes with a liquid dielectric material, curing the liquid dielectric material to provide electrical insulation and protection, curing the upper glass element, and surfacing the upper glass element.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein.

Embodiments of the present disclosure will now be described, by way of example only, with reference to the following diagrams. The drawings included herewith are for illustrating various examples of articles, methods, and apparatuses of the present specification. In the drawings:

FIG. 1 illustrates a system architecture of a dual-function retrofittable electrodynamic cleaning system 100 for dust and snow removal, in accordance with embodiments of the present disclosure;

FIG. 2 is a schematic diagram of a dual-function device 200 for dust and snow removal from a solar panel, in accordance with embodiments of the present disclosure;

FIG. 3 is a side view of the dust or debris removal functionality of the dual-function device of FIG. 2 in isolation, in accordance with embodiments of the present disclosure;

FIG. 4 is a side view of the snow or ice removal functionality of the dual-function device 400 of FIG. 2 in isolation, in accordance with embodiments of the present disclosure;

FIG. 5a is a side view of the film layers of the dual-function device 500 for retrofitting to an existing solar panel, in accordance with embodiments of the present disclosure;

FIG. 5b is a side view of the dual-function device of FIG. 2 integrated into the solar panel, in accordance with embodiments of the present disclosure;

FIG. 6 is a perspective view of a solar panel showing fingers, bus bars, and inter-cell gaps therein, in accordance with embodiments of the present disclosure;

FIGS. 7a and 7b are top views of a snow removal circuit integrated into or retrofitted to a solar panel, respectively shown as parallel lines and as series lines, in accordance with embodiments of the present disclosure;

FIG. 8 is a top view of a dust removal circuit, integrated into or retrofitted to a solar panel, shown as three parallel phases, in accordance with embodiments of the present disclosure;

FIG. 9a is a schematic view of a dual-function two-layer circuit, in accordance with embodiments of the present disclosure;

FIG. 9b is a top view of the dual-function two-layer circuit of FIG. 9a integrated into or retrofitted to a solar panel, in accordance with embodiments of the present disclosure;

FIG. 9c is a schematic view of a junction box as shown in FIG. 9b, in accordance with embodiments of the present disclosure;

FIG. 10 is a schematic diagram of a control circuit and power source for the dual-function two-layer circuit of FIGS. 9a and 9b as integrated into or retrofitted to a solar panel as shown in FIG. 9b, in accordance with embodiments of the present disclosure;

FIG. 11a is a top view of a dual-function one-layer circuit integrated into a solar panel, in accordance with embodiments of the present disclosure;

FIG. 11b is a top view of a snow-removal one-layer circuit integrated into a solar panel, in accordance with embodiments of the present disclosure;

FIG. 12 is a schematic diagram of a power and control circuit and power source for the one-layer dual-function circuit of FIG. 11a as integrated into a solar panel, in accordance with embodiments of the present disclosure;

FIG. 13 is a flow diagram of a method of dust or debris and snow or ice removal about a solar panel, in accordance with embodiments of the present disclosure;

FIGS. 14a-14c are sectional views of another embodiment of the dual-function device for dust or debris and snow or ice removal about a solar panel being assembled, in accordance with embodiments of the present disclosure;

FIG. 14d is a side sectional view of a complete solar panel, with the device of FIGS. 14a-14c installed therein, in accordance with embodiments of the present disclosure;

FIG. 15 is a schematic diagram of a dual-function, two-layer system integrated into the panel with internal snow removal heaters in the inter-cell gaps and a DFERF dust-removal layer near the front glass, in accordance with embodiments of the present disclosure; and

FIG. 16 illustrates the method of assembling the dual-function device shown in FIGS. 14a-14c, in accordance with embodiments of the present disclosure.

### DETAILED DESCRIPTION OF EMBODIMENTS

Various apparatuses or processes will be described below to provide an example of each claimed embodiment. No embodiment described below limits any claimed embodiment, and any claimed embodiment may cover processes or apparatuses that differ from those described below.

The claimed embodiments are not limited to apparatuses or processes having all of the features of any one apparatus or process described below or to features common to multiple or all of the apparatuses described below.

Further, although process steps, method steps, algorithms, or the like may be described (in the disclosure and/or in the claims) in a sequential order, such processes, methods, and algorithms may be configured to work in alternate orders. In other words, any sequence or order of steps that may be described does not necessarily indicate a requirement that the steps be performed in that order. The steps of the processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

Embodiments described in the disclosure and configurations shown in the drawings are merely examples of the embodiments of the disclosure and may be modified in various different ways. In addition, the same reference numerals or signs shown in the drawings of the disclosure indicate elements or components performing the same function.

Throughout the present disclosure, various synonyms may be used to refer to dust, debris, or contaminants that are cleared, removed, or otherwise mitigated by the present disclosure. It will be appreciated that all such synonyms and mitigation are to be considered as a first functionality of the present disclosure.

Throughout the present disclosure, various synonyms may be used to refer to snow, ice, or substances that are cleared, removed, or otherwise melted or mitigated by the present disclosure. It will be appreciated that all such synonyms and mitigation are to be considered a second functionality of the present disclosure.

The following relates to photovoltaic modules or solar panels, and more particularly to devices for removing dust or debris and snow or ice from the photovoltaic modules and methods of removing dust or debris and snow or ice from photovoltaic modules.

Various embodiments include at least one of systems, methods, and software to facilitate automatic (e.g., autonomous) photovoltaic modules surface cleaning. Solar power surfaces can include, but are not limited to, photovoltaic modules, photovoltaic (PV) solar cells, mirrors used in Concentrating Solar Power (CSP) plants, other surfaces, and combinations thereof. Surfaces can be used to generate solar power either directly or indirectly. The solar panel and the photovoltaic module can be interchangeably used in the patent specification.

It should first be noted that the systems and methods will be discussed below with reference to a photovoltaic module or a solar panel. Furthermore, it is to be noted that the systems and methods of the present disclosure can be used with any system, including, but not limited to, windows, vehicle surfaces, vehicle windshields, optical devices, etc., such that the electrodynamic shield allows for automatic cleaning of such objects.

In one embodiment, the system architecture is illustrated using block diagrams, where arrows represent data flow and communication pathways between modules. The arrows indicate the direction in which information, model parameters, or control signals are transmitted from one component to another. The arrows do not imply a specific physical medium or network protocol and denote logical communication relationships between modules within the system.

In particular, the present disclosure provides the dual-function electrodynamic retrofit film (DFERF), including nanomaterial electrodes (NMEs) for applying to a solar panel. The DFERF may include both a dust or debris removal functionality and a snow or ice removal functionality.

As used herein, “Dual-Function electrodynamic retrofit film (DFERF)” is a transparent film device that can be applied onto an existing surface (e.g., a solar panel) to provide two functions, electrodynamic dust removal and resistive snow/ice melting using an integrated network of electrodes. In the context of a newly manufactured panel, the same structure can be built as an integrated component of the panel (often referred to in this context as a dual-function retrofittable transparent film, DFERF).

As used herein, the term “electrodynamic retrofittable film (ERF)” is defined as a transparent layer that is placed on the surface of the photovoltaic module or solar panel and is designed to keep the panel clean. The film contains thin electrodes that receive an electrical signal. When a controlled three-phase high-voltage signal is applied, the film creates a moving electric field along its surface. The moving electric field pushes, lifts, and moves dust and small particles off the solar panel. The cleaning process restores solar energy output and does not require water, brushes, or any mechanical cleaning parts.

As used herein, the term “an electrodynamic travelling wave” is a moving electric field created along a surface or structure by applying multiple electrical signals with controlled phase differences to a set of electrodes. The phase-shifted signals cause the electric field to propagate in a defined direction over time. As the electric field travels, it exerts electrostatic forces on nearby charged or polarizable particles, causing them to move in the same direction as the wave. This effect can be used to transport, repel, or remove particles, such as dust, without physical contact.

As used herein, the term “Power and Control Unit (PCU)” is an electronic subsystem configured to supply electrical power and control signals to other components of a system for managing energy. The PCU comprises an inverter, a boost converter to increase voltage, and a DC-DC converter to lower voltage. The electronic control system that powers the nanomaterial electrodes (NMEs) and manages mode switching. The PCU typically includes power electronics (voltage/current sources derived from the solar panel or a battery), a switching matrix to toggle electrode connections between modes, and a controller (microprocessor or analog logic) to decide when and how to activate each cleaning mode.

As used herein, the term “Nanomaterial Electrode (NME)” a conductive electrode made of nanoscale or transparent conductive materials, such as silver nanowires (AgNW), carbon nanotube (CNT) networks, graphene, or transparent conductive oxides like indium tin oxide (ITO). NMEs are used in the film to form the thin, transparent electrode patterns that perform the dust and snow removal functions.

As used herein, the term “Photovoltaic (PV) Cells and Panel Structure” is a solar panel typically consists of multiple silicon solar cells wired together. Solar cells have metallic fingers (fine grid lines) and bus bars (larger strips) printed on its surface to collect current. Inter-cell gaps refer to the spaces between cells in the panel, and a front glass (typically tempered glass) covers the cells for protection.

As used herein, “active elements” of a panel refers to the power-generating cell areas, whereas inactive areas include the metallization lines (fingers/busbars) and inter-cell gaps where no light-to-electricity conversion occurs.

As used herein, “Electrodynamic Screens (EDS)” is a technology for dust removal that uses oscillating or traveling electric fields to impart charges and forces on particles. In the disclosed embodiments, the dust removal mode creates an electrostatic moving wave on the surface of the solar panel, the nanomaterial electrodes (NMEs) generate a moving electric field that charges dust and ejects it from the surface without physical contact.

As used herein, the term “soiling level” refers to the degree of dirt, dust, or buildup on a surface.

As used herein, the term “Maximum Power Point Tracking” (MPPT) is an algorithm that is included in charge controllers used for extracting maximum available power from photovoltaic modules under multiple conditions. The voltage at which a photovoltaic module can produce maximum power is called the maximum power point (or peak power voltage). Maximum power varies with solar radiation, ambient temperature, and solar cell temperature.

The following detailed description outlines various embodiments of a retrofittable cleaning system (RECS) with Dual-Function Electrodynamic Retrofit Film (DFERF) and methods for its use. All examples given are illustrative and not intended to limit the scope of the invention, which is defined by the claims. For clarity, in the figures and description, like parts are given like reference numerals.

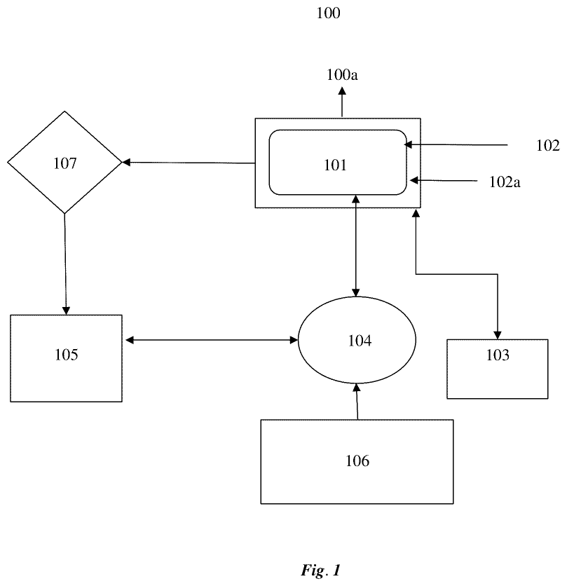

Referring now to FIG. 1, shown therein is a schematic diagram of a dual-function retrofittable electrodynamic cleaning system (RECS) 100 with a dual-function device 100a of FIG. 1, according to an embodiment. FIG. 1 illustrates a system architecture of the dual-function retrofittable electrodynamic cleaning system (RECS) 100 comprising a dual-function electrodynamic retrofit film (DFERF) 101 configured for installation on a solar panel 102, a plurality of sensors 103, a power and control unit (PCU) 104, and a software module 105, and external system components including the solar panel 102, an input DC voltage source 106 (optional external power source), and optionally a software module 105 for third-party solar monitoring. The device 100a is disposed on a solar panel 102 with a dust-free dual-function electrodynamic retrofit film (DFERF) 101 of the device 100a of the system 100. The system 100 further includes a power and control unit (PCU) 104 coupled to an external power source, such as but not limited to the input DC voltage source 106. The input DC voltage source 106 may comprise an external battery electrically connected to the power and control unit (PCU) 104. As previously described, the DFERF 101 consumes a fraction of the electrical output generated by the solar panel 102 for dust or debris removal or snow or ice removal, such that the solar panel 102 is capable of supplying power directly to the power and control unit (PCU) 104 and/or to an external battery connected thereto for energy storage. The voltages and currents for operation of the device 100a in both a dust or debris removal mode and a snow or ice removal mode are compatible with the electrical output of a solar panel 102. In the upcoming embodiments, a dust or debris removal mode or circuit, functionality, or operation can be interchangeably referred to as dust removal and similarly, a snow or ice removal mode or circuit or functionality or operation can be interchangeably referred to as snow removal mode, circuit, functionality, or operation.

The device 100a further includes a plurality of sensors 103 configured to measure operating conditions, status, or output of the system 100, including, but not limited to, snow weight, temperature, or power output of the solar panel 102. Sensors 103 are operatively coupled to the power and control unit (PCU) 104 to enable automated switching between dust or debris removal and snow or ice removal modes based on detected conditions. For example, a decrease in power output in combination with reduced temperature and increased panel loading may indicate snow accumulation, whereas a decrease in power output in combination with elevated temperature may indicate dust or debris accumulation. In certain embodiments, the power and control circuitry of the system 100 is integrated within an existing junction box of the solar panel 102, thereby reducing system complexity and installation footprint.

The system 100 further includes an application (App) 107 configured to provide automatic and/or manual control of the device 100a. The App 107 may monitor voltage and current output of one or more solar panels 102 and determine whether to activate dust or debris removal or snow or ice removal modes. The App 107 may further incorporate external data sources, including weather forecast information, to anticipate environmental conditions and optimize cleaning operation timing. In certain embodiments, centralized monitoring via the App 107 eliminates the need for sensors 103 on each of the solar panels 102. The system 100 may additionally interface with the software module 105. The software module 105 may include one or more solar monitoring applications configured to track performance data of the solar panel 102, including detection of power loss, activation of the device 100a, verification of restored power output following cleaning, and subsequent deactivation of the cleaning function.

In a typical installation, the dual-function electrodynamic retrofit film (DFERF) 101 is a thin, transparent film installed on a front glass surface 102a of the solar panel 102 and includes an interdigitated electrode pattern, including nanomaterial electrodes, disposed across at least a portion of an active area of the solar panel 102. The software module 105, executed by the power and control unit (PCU) 104, a remote computing device, or a combination thereof, processes measurements from the plurality of sensors 103 and operational data to generate control signals that actuate the DFERF 101, monitor system performance, detect faults, estimate soiling levels with or without a dedicated soiling sensor, predict degradation or failure conditions, and determine cleaning schedules based on historical and real-time correlations between environmental conditions, electrical output, and performance deviations. Cleaning operations may be initiated automatically or recommended for execution, and in an alternative standalone configuration, the software module 105 operates independently of the DFERF 101 to monitor photovoltaic performance, predict energy losses, and generate maintenance schedules.

In particular, the present disclosure provides a dual-function electrodynamic retrofit film (DFERF) 101, including nanomaterial electrodes (NMEs) for applying to a solar panel. The DFERF may include both a dust or debris removal functionality and a snow or ice removal functionality.

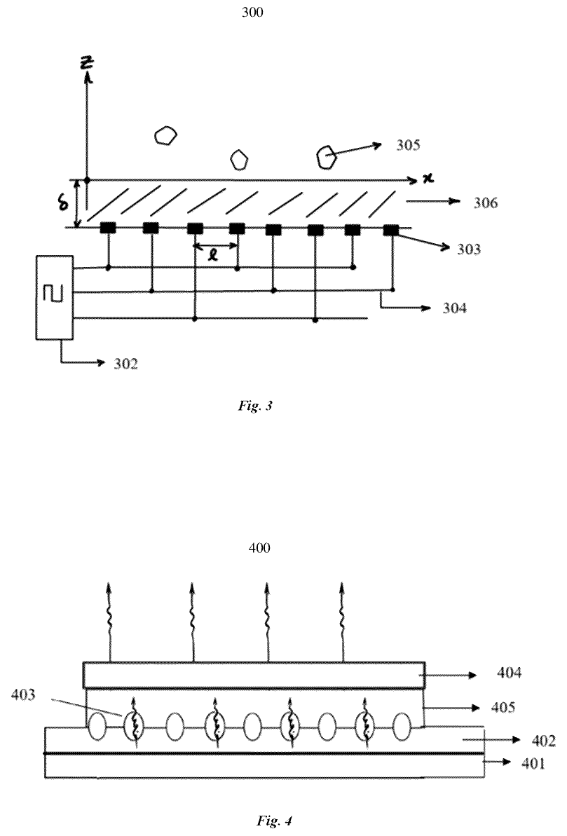

In particular, the present disclosure provides a device where the NMEs are embedded in respective upper and lower grooves. When operating in the dust removal functionality, the NMEs generate forces large enough to overcome the natural forces acting on the dust particles to effectively repel the dust particles. The forces acting on a particle near the DFERF surface may include gravitational force (Fg), image force (Fi), electrostatic (Coulomb) force (Fc) dielectrophoretic (DEP) force (Fdep), and aerodynamic drag (air resistance) force (Fd). During dust-removal operation, an electric field generated by the energized nanomaterial electrodes (NMEs) is configured to produce a net force that overcomes gravity and drag and that enables particle detachment and transport along the surface. In general, DEP and image forces tend to attract particles toward regions of high electric-field intensity (toward the surface/electrodes), while the Coulomb force can provide a repulsive component that lifts and transports the particle away from the surface depending on the particle charge polarity and the instantaneous field direction. When the NMEs are driven with a multi-phase waveform (e.g., three-phase), the resulting electric field forms a travelling wave that transports particles along the light-receiving surface. An example electrode arrangement and associated particle motion is illustrated in FIG. 3. Solving Laplace's equation subject to the boundary conditions of the electrode geometry yields an evanescent electric-field distribution of the form:

$$\vec{E} = α {E}_{0} [ cos ( ω t - kx ) \hat{z} - sin ( ω t - kx ) \hat{x} ] {e}^{- kz}$$

where E0≈V/l, with V denoting the voltage amplitude of the applied multi-phase signal and l denoting an effective electrode spacing (e.g., phase-to-phase distance), and where a is a constant that depends on the electrical and dielectric properties of the intervening dielectric layer (see FIG. 3).

The Coulomb force on a charged particle is: Fc=qE. Depending on the polarity and sign convention of the charged particle, the particle may translate in the direction of the travelling wave or opposite thereto. Particle charge q may arise from polarization of a dielectric particle and/or induction charging of a conducting particle in the presence of the applied field. The time-varying electric fields can lead to charge accumulation near the surface, which contributes to particle charging. In one embodiment, the induced charge on a particle is related to an accumulated surface charge density σs by: q=4πr²σs; where r is an effective particle radius. The surface charge density σs may be estimated from a charging model of the form: σs~Bε₀E₀, Where ε₀ is the permittivity of free space and β is a proportionality constant that depends on the electrical and dielectric properties of the dielectric layer (e.g., material permittivity, thickness, and interfacial conditions).

Because the Coulomb force qE is a principal driving mechanism for dust-removal operation, performance of the DFERF may be evaluated based on the magnitude of the particle charge q and the generated electric field E. Additionally, deposited particles exposed to the non-uniform electric field distribution near the DFERF surface experience dielectrophoretic (DEP) forces. In some embodiments, DEP contributes to initial particle motion and/or charging, particularly at early times when particles have little or no net charge. The net force acting on the particle may be expressed as:

$$\vec{F} = q \vec{E} - \frac{{q}^{2}}{16 π {ϵ}_{0} {ϵ}_{s} {r}^{2}} + 4 π {ϵ}_{0} {r}^{3} \frac{{ϵ}_{p} - 1}{{ϵ}_{p} + 2} ∇ {\vert E \vert}^{2} - 6 π η r \vec{v} - \frac{4 π {r}^{3}}{3} {ρ}_{p} \vec{g}$$

Solving for the travelling-wave field and the induced charge model described herein yields electrical force expressions of the form:

$$\overline{F} = 2 π {α}^{2} β {E}_{0}^{2} {ϵ}_{0} {r}^{2}$$

In one embodiment, particle motion initiates when the electric field magnitude exceeds a minimum threshold E_{0,min} where: E_{0,min}~\sqrt{r}. And, after motion initiates, a particle velocity may be estimated as: v~E₀²r.

When the DFERF is operating in the ice and snow removal functionality, several variables are to be considered for the analysis of heat transfer within a solar panel system, particularly focusing on a single row of NMEs and the interaction thereof with the surrounding melting ice. These variables are defined as follows:
A: The area of the surface of the solar panel
Tair (° C.): Temperature of outside air
T0 (° C.): The melting point at which ice transitions to water
Tout (° C.): Temperature at the outer (ice-facing) surface of the NME.
Tin (° C.): Temperature at the inner surface of the NME (toward the substrate).
σs (Ω·cm): Electrical conductivity of the NME material
R: Radius of the (approximately cylindrical) NME
V: Applied voltage along the heating line
d: Instantaneous thickness of the ice layer
l: Length of the NME line
n: Number of parallel NME heating rows
Ks (W/m·C): Thermal conductivity of the NME material
KI (W/m·C): Thermal conductivity of ice
hw (W/m2° C.): Effective heat-transfer coefficient between NME and melting ice
Lf (J/kg): Latent heat of fusion of ice to water
ρI (kg/m3): Density of ice
   At a given radius r from the center of an NME conductor, the steady-state heat balance inside the ink (NME material) can be written in the form of a radial conduction equation with volumetric heat generation. At a given radius r from the center, the heat transfer equation within the ink may be expressed as follows:

$$2 π r {σ}_{s} {V}^{2} / l = - {K}_{s} 2 π rl ( \frac{{d}^{2} T}{{dr}^{2}} ) , ( {( \frac{dT}{dr} )}_{r = 0} = 0.$$

which results in temperature at the inner surface of the NME:

$${T}_{in} = {T}_{out} + \frac{{σ}_{s} {V}^{2} {R}^{2}}{2 {K}_{s} {l}^{2}}$$

For the outer layer of the nanomaterial electrodes (NMEs), the heat transfer rate equation between the nanomaterial electrodes (NMEs) and the ice is derived as:

$$π {R}^{2} {V}^{2} {σ}_{s} / l = 2 π {Rh}_{w} l ( {T}_{out} - {T}_{0} )$$

$$Therefore :$$

$${T}_{out} = {T}_{0} + \frac{{σ}_{s} {V}^{2} R}{2 {h}_{w} {l}^{2}} {T}_{in} = {T}_{0} + \frac{{σ}_{s} {V}^{2} R}{2 {l}^{2}} ( \frac{1}{{h}_{w}} + \frac{R}{{K}_{s}} ) .$$

Considering the electrical energy input and the counteracting effect of cold air, the heat transfer within the melting ice can be conceptualized as follows:

$${ρ}_{I} {L}_{f} A {d}^{′} ( t ) = \frac{n π {R}^{2} {V}^{2} {σ}_{s}}{l} - \frac{{K}_{I} A ( {T}_{0} - {T}_{air} )}{d} .$$

In the above equation, d′(t) represents the rate of change in ice thickness over time, indicating how quickly the ice melts.

In one embodiment, the thermal and electrical behavior of the nano-material electrode (NMEs) network during snow and ice removal is governed by resistive heating within the nanomaterial electrodes (NMEs) and heat transfer to the surrounding environment. When a direct-current voltage is applied along the length of a nano-material electrode having uniform electrical conductivity and geometry, electrical energy is dissipated uniformly as heat within the electrode material. This internally generated heat conducts radially through the electrode, establishing a temperature gradient between an inner region of the electrode and an outer surface adjacent to the surrounding snow or ice layer.

The temperature at the outer surface of the electrode is determined by an energy balance between the resistive heat generated within the electrode and convective heat transfer into the adjacent ice or meltwater. As a result, the outer surface temperature of the electrode rises above the ambient ice temperature by an amount dependent on the applied voltage, electrode dimensions, material conductivity, and the local heat transfer conditions at the electrode-ice interface. Due to radial heat conduction through the electrode material, the inner region of the electrode reaches a higher temperature than the outer surface.

In operation, the heat delivered by one or more electrodes to an overlying ice layer produces melting at a rate determined by the balance between electrical heating power supplied by the nanomaterial electrodes (NMEs) and heat losses to the colder ambient environment, including conductive heat loss through the ice layer to the surrounding air. The resulting rate of change of ice thickness over time depends on the applied electrical input, the number and geometry of the nanomaterial electrodes (NMEs), and the thermal properties of the ice and ambient conditions. When the net heat balance is positive, the ice layer progressively thins and is removed within a desired time interval.

In an alternative embodiment, during dust-removal operation, the same nano-material electrodes are driven in an electrodynamic mode in which the nanomaterial electrodes (NMEs) are electrically open-ended and generate oscillating electric fields. In this mode, power dissipation and heating are negligible, and the nanomaterial electrodes (NMEs) function primarily to impart electrostatic forces to dust particles. Accordingly, the same electrode network is selectively operable in a field-generation mode for dust removal or in a resistive heating mode for snow and ice removal. By selecting operating parameters based on environmental conditions, the electrode network balances electrostatic performance and heating capability to optimize year-round energy yield using a common electrode architecture.

In an embodiment, the DFERF is retrofitted to existing solar panels, i.e., installed onto solar panels that are already deployed in the field, offering flexibility in installation and providing enhancements to performance, particularly in environments prone to dust accumulation and snow cover. Also, in some embodiments, the DFERF is integrated directly into the manufacture of a snow free and dust free solar panel, thereby providing for new solar panels that come with built-in dust and snow removal functionality.

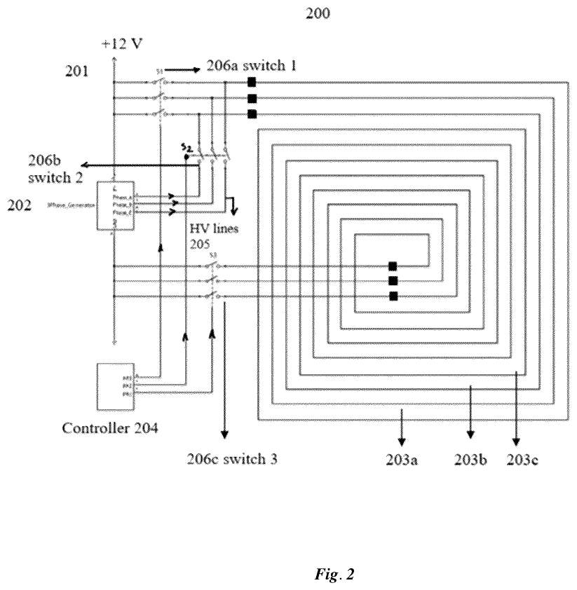

Referring now to FIG. 2, shown therein is a schematic diagram of a dual-function device 200 for dust or debris and snow or ice removal about a solar panel, according to an embodiment. The schematic diagram in FIG. 2 further shows a design for the configuration of the nanomaterial electrodes (NMEs) 203a, 203b, and 203c. The device 200 includes a dual-function electrodynamic retrofit film (DFERF) 201 for applying to a solar panel. The dual-function electrodynamic retrofit film (DFERF) 201 may be retrofitted to a solar panel. Also, the dual-function electrodynamic retrofit film (DFERF) 201 may be integrated into the solar panel such that the dual-function electrodynamic retrofit film (DFERF) 201 can be manufactured with or as a part of the solar panel. The device 200 further includes a high-voltage (HV) three-phase voltage generator 202 configured to generate multi-phase drive signals, and a controller 204 operatively coupled thereto to control the NMEs between dust and snow removal functionalities. The power generators for generating or otherwise providing electricity to the dual-function electrodynamic retrofit film (DFERF) 201 for performing the functions of dust or debris removal and snow or ice removal, as further described with respect to FIGS. 3 and 4, respectively.

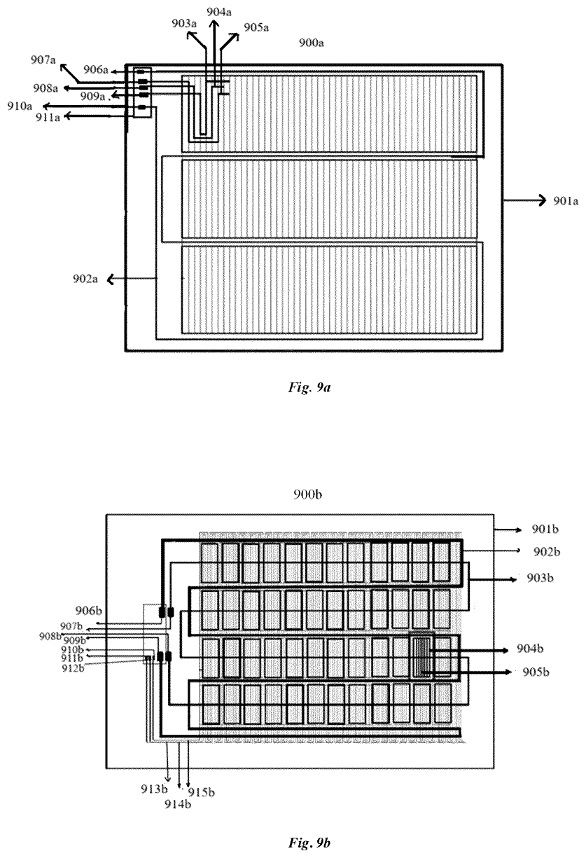

In one embodiment, the device 200 includes a controller 204 configured to control dual functionality between (i) a dust or debris removal mode and (ii) a snow or ice removal mode. The controller 204 is operatively coupled to a switching network including switches 206a, 206b, and 206c, which are configured to selectively couple the nanomaterial electrodes (NMEs) 203a-203c to (a) a DC supply (e.g., 12 V DC), (b) ground, or (c) high-voltage (HV) drive lines 205 generated by the HV three-phase voltage generator 202. In the dust or debris removal mode, switch 206b is closed to couple first ends of the NMEs 203a-203c to the HV drive lines 205, while switch 206c is open such that second ends of the NMEs are left floating (open-circuited), thereby establishing a non-uniform electric field that propagates along the electrode pattern (e.g., as illustrated in FIG. 3) to repel and remove dust or debris. In the snow or ice removal mode, switch 206b is open to decouple the NMEs from the HV drive lines 205, switch 206a is closed to couple the first ends of the NMEs to the DC supply, and switch 206c is closed to couple the second ends of the NMEs to ground, thereby forming a closed circuit through which current flows to generate heat for snow/ice removal (e.g., as illustrated in FIG. 4). Additional embodiments of the dual-function electrodynamic retrofit film (DFERF) and associated switching arrangements are described with reference to FIGS. 9-12.

In the dust removal mode, the nanomaterial electrodes (NMEs) 203 function as electrostatic force generators that produce a traveling wave to charge and repel dust particles, as illustrated in FIG. 3. In the snow removal mode, the nanomaterial electrodes (NMEs) 203 function as resistive heaters capable of generating desired temperatures to melt snow or ice from a solar panel. Accordingly, the dual-function electrodynamic retrofit film (DFERF) 201 in FIG. 2 is selectively operable between the foregoing modes based on application requirements, thereby providing the dual-function device 200 incorporating the dual-function electrodynamic retrofit film (DFERF) 201. The dual-function electrodynamic retrofit film (DFERF) 201 may be configured to operate using a negligible portion of electrical output from the solar panel 301 or from an integrated energy storage device, thereby enabling sustained operation over extended periods. Finally, the plurality of sensors 103 based power and control unit (PCU) 104 may be integrated with the DFERF 101 of the solar panel 102, as shown in FIG. 1, to automate the activation of the nanomaterial electrodes (NMEs) 203.

In a preferred embodiment, in order to provide for desired transparency, conductivity, and resistivity within the DFERF 101 of the solar panel 102, the nanomaterial electrodes 108 are formed of any one or more of silver nanowires (AgNW), Indium Tin Oxide (ITO), and/or copper (Cu), and the film 102 may be made of Polyethylene Terephthalate (PET), tempered glass, plexiglass/acrylic and/or any suitable NME-substrate combination that meets the heating specifications of a particular implementation.

Referring to FIG. 3, shown therein is a side view of the dust or debris removal functionality of the dual-function device 300. The dust or debris removal functionality can also be referred to as Electrodynamic (Field-Generation) Mode. The device 300 comprises a plurality of nanomaterial electrodes (NMEs) 303. The plurality of nanomaterial electrodes (NMEs) 303 are visibly connected to three phase voltage lines 304a, 304b, 304c wherein the power is generated by one or more power generators 302. The device 300 further includes a protective barrier 306 for shielding the device 300, specifically the nanomaterial electrodes (NMEs) 303, from the plurality of dust particles 305.

In a primary operating mode of the dual-function device 300 known as Electrodynamic (Field-Generation) Mode, the nanomaterial electrodes (NMEs) 303, are configured as open-ended conductive traces patterned on a surface of the dual-function electrodynamic retrofit film (DFERF) disposed of on the solar panel 301. In this mode, a multi-phase, high-voltage waveform is applied to the nanomaterial electrodes (NMEs) 303 via three phase voltage lines 304a, 304b, 304c, which are electrically coupled to the power generator 302. The open-ended configuration of the nanomaterial electrodes (NMEs) 303 results in the absence of a direct DC return path, such that current flow through each of the nanomaterial electrodes (NMEs) 303 is displacement current. As a result, resistive power dissipation within the nanomaterial electrodes (NMEs) 303 is negligible. In this configuration, the dual-function electrodynamic retrofit film (DFERF) behaves as a distributed capacitive structure relative to the solar panel and the surrounding environment, thereby generating spatially varying or traveling electric fields above the surface of the solar panel 301. These electric fields impart electrostatic forces on the plurality of dust particles 305, causing the plurality of dust particles 305 to be charged and displaced from the surface of the solar panel 301, while the protective barrier 306 shields the nanomaterial electrodes (NMEs) 303 from direct exposure to particulate matter.

In one example embodiment, the multi-phase waveform applied to the nanomaterial electrodes (NMEs) 303 comprises two or more electrical phases, including, but not limited to, two-phase, three-phase, or multi-phase excitation. Each phase may have a peak-to-peak voltage in a range of approximately 1000 volts to 5,000 volts and may be applied at a frequency in a range of approximately 1 Hz to 10 Hz, such that spatially varying or traveling electric fields are generated across the surface of the solar panel to induce electrostatic forces on a plurality of dust particles 305.

In another example embodiment, each of the nanomaterial electrodes (NMEs) 303 includes at least one electrically floating end that is not coupled to a direct current return path. The floating end may be electrically isolated by a dielectric layer, an insulating gap, or a termination structure integrated into the dual-function electrodynamic retrofit film (DFERF), such that current flow through the nanomaterial electrodes (NMEs) 303 during operation is the displacement current. In one embodiment, adjacent nanomaterial electrodes (NMEs) 303 are sequentially energized with a controlled phase offset to generate a traveling electric field propagating along the surface of the solar panel 301.

Referring now to FIG. 4, shown therein is a side view of the snow or ice removal functionality of the dual-function device 400. The dual-function device 400 is integrated to a solar panel 401 with dual-function electrodynamic retrofit film (DFERF) 402 and plurality of nanomaterial electrodes (NMEs) 403. The dual-function electrodynamic retrofit film (DFERF) 402 is not separate from the solar panel 401 but is labelled for ease of reference. FIG. 4 illustrates the working principle of the snow removal functionality of the dual-function device 400 using the dual-function electrodynamic retrofit film (DFERF) 402 heating mode.

The dual-function device 400 is selectively operable in a heating mode configured to remove ice or snow layer 404 from the surface of the solar panel 401. In this mode, the nanomaterial electrodes (NMEs) 403, which are otherwise configured for electric-field generation, are selectively reconfigured to form a closed electrical conduction path such that the nanomaterial electrodes (NMEs) 403 function as distributed resistive heating elements. The closed conduction path is formed by selectively coupling one or more previously electrically floating electrode terminations via switching circuitry of the dual-function device 400, without modifying the physical layout of the nanomaterial electrodes (NMEs) 403.

Electrical power is supplied to the nanomaterial electrodes 403 from an upstream power source electrically coupled to the solar panel 401, and a controlled current is conducted through the nanomaterial electrodes (NMEs) 403 to generate localized resistive heating within the dual-function electrodynamic retrofit film (DFERF). The generated heat raises the temperature of the dual-function electrodynamic retrofit film (DFERF) 402 and the ice layer 404 adjacent to the dual-function electrodynamic retrofit film (DFERF) 402 induce phase change of the ice to water 405, thereby facilitating removal of accumulated snow or ice from the surface of the solar panel 401. The heating is spatially distributed across the surface of the solar panel 401 in accordance with the electrode pattern, thereby avoiding localized hot spots and reducing thermal stress on the solar panel 401.

From a circuit topology perspective, the dual-function electrodynamic retrofit film (DFERF) transitions between (i) an open-loop configuration exhibiting capacitive behavior during an electrodynamic cleaning mode and (ii) a closed-loop configuration exhibiting resistive behavior during the heating mode. This transition is implemented by selectively reconfiguring electrical interconnections of the nanomaterial electrodes (NMEs) 403 within the power and control circuitry of the dual-function device 400, thereby enabling both electrodynamic cleaning and thermal ice removal using a common electrode architecture.

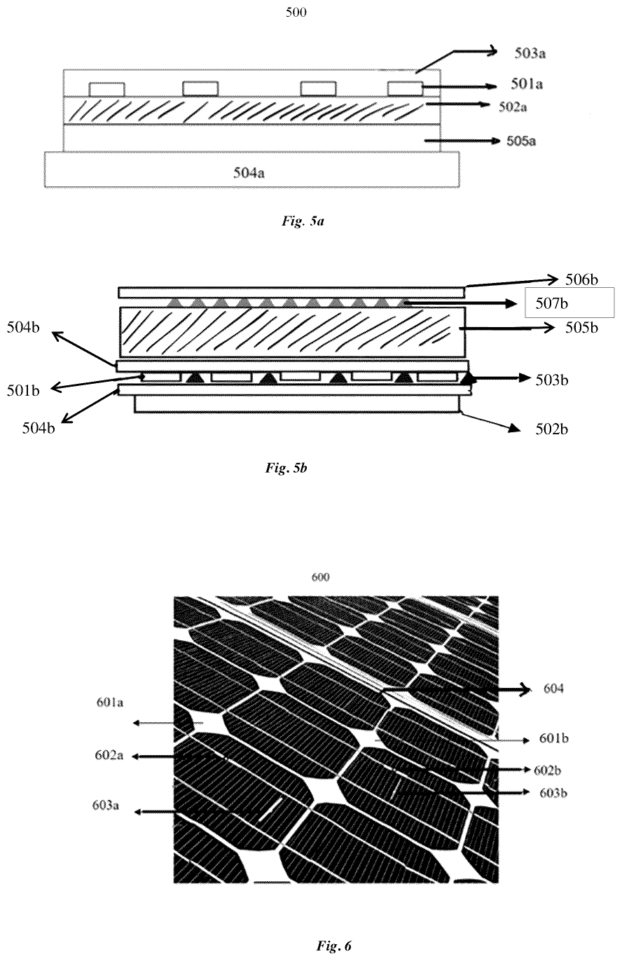

FIG. 5a is a side view of the film layers of the dual-function device 500 for retrofitting to an existing solar panel. Referring now to FIG. 5a, shown therein is a side view of film layers 500 of a dual-function electrodynamic retrofit film (DFERF) configured for installation on dual-function device of the solar panel 504a. As illustrated in FIG. 5a, the film layers 500 include a substrate 502a, and nanomaterial electrode (NME) layer 501a disposed on the substrate 502a, and a protective coating 503a disposed over at least a portion of the nanomaterial electrode (NME) layer 501a, and an adhesive layer 505a configured to couple the substrate 502a to the solar panel 504a.

In an embodiment, the nanomaterial electrode (NME) layer 501a is formed by depositing a conductive material onto the substrate 502a in a predetermined pattern. In certain embodiments, the conductive material comprises a transparent conductive material, including indium tin oxide (ITO), but is not limited to, selected to permit transmission of incident light through the film layers 500 while providing electrical conductivity for electrodynamic and thermal operation.

In other embodiments, the conductive material comprises a non-transparent conductive material, including, but are not limited to, copper-based conductive ink or silver nanowire ink. In such embodiments, the electrode pattern of the nanomaterial electrode (NME) layer 501a is configured to align with preexisting non-transparent features of the underlying solar panel 504a, including bus bars or finger conductors, thereby limiting incremental optical loss attributable to the retrofit film.

The substrate 502a comprises a flexible, optically transmissive polymer material configured to mechanically support the nanomaterial electrode (NME) layer 501a and conforms to a surface of the solar panel 504a. In a preferred embodiment, the substrate 502a comprises polyethylene terephthalate (PET), but is not limited to. The substrate 502a may further include an adhesive layer or be used in conjunction with a separate adhesive material to secure the film layers 500 to the solar panel 504a, wherein the adhesive is selected to maintain adhesion over a range of environmental conditions without materially affecting optical transmission or electrical performance.

The protective coating 503a comprises a dielectric material disposed over the nanomaterial electrode (NME) layer 501a and configured to electrically insulate the nanomaterial electrode (NME) layer 501a from the surrounding environment. The dielectric material increases effective electric field coupling during electrodynamic operation and provides a physical barrier against moisture ingress, particulate contamination, and mechanical abrasion. In certain embodiments, the protective coating 503a renders the film layers 500 resistant to water exposure under outdoor operating conditions.

In one embodiment, the protective coating 503a is applied as a continuous dielectric layer covering the surface area of the nanomaterial electrode (NME) layer 501a, for example, by laminating a transparent polymer film over the nanomaterial electrode (NME) layer 501a. In another embodiment, the protective coating 503a is selectively applied to one or more regions corresponding to conductive portions of the nanomaterial electrode (NME) layer 501a, leaving intervening regions of the substrate 502a uncovered to improve optical transmission. Selective application of the protective coating 503a may be achieved using patterned deposition, conformal coating, or localized resin application techniques, but are not restricted to. The selection between continuous and selective application of the protective coating 503a may be based on environmental exposure requirements, optical transmission targets, and durability specifications.

Referring now to FIG. 5b, shown therein is a side view of film layers 500 integrated into solar panel, according to an embodiment. FIG. 5b illustrates an integrated configuration in which first and second nanomaterial electrodes (NMEs) layer 503b and 507b are incorporated within the solar panels 501b, adjacent to the solar cell layer thereof.

In the embodiment shown in FIG. 5b, a first nanomaterial electrodes (NMEs) layer 503b is integrated within the solar cell stack of the solar panel 501b and is configured primarily for snow or ice removal functionality, while a second nanomaterial electrodes (NMEs) layer 507b is disposed above the solar panel glass 505b and configured primarily for dust or debris removal functionality. The nanomaterial electrodes (NMEs) layer 507b used for dust removal may be thinner than the nanomaterial electrodes (NMEs) layer 503b used for snow or ice removal and is particularly suited for generating electrodynamic fields for electrostatic displacement of dust particles.

As illustrated, an integrated nanomaterial electrode (NME) arrangement is disposed of within the solar panel layer stack. In the illustrated embodiment, a lower NME layer 503b is positioned within the laminate adjacent to the solar cells 501b (at the cell plane). An upper NME layer 507b is formed on a front-side glass layer 505b, such as by printing the NMEs 507b directly onto the glass layer 505b, and the upper NME layer 507b is covered by a protective coating layer 506b configured to protect the NMEs from environmental exposure and abrasion. One or more encapsulant layers 504b (e.g., EVA) are disposed within the stack, including a lower encapsulant layer 504b disposed above a back sheet 502b, and additional encapsulant material 504b disposed such that the lower NME layer 503b is encapsulated between encapsulant layers 504b and laminated between the front-side glass layer 505b and the back sheet 502b. In this manner, the NME layers 503b and 507b are integrated into the module stack while remaining electrically connectable to associated circuitry.

The first nanomaterial electrode (NME) layer 503b, disposed at or proximate the solar cell level 501b, may be aligned relative to the solar cells and may be selectively coated in accordance with the selective-coating embodiment described herein. In embodiments in which the integrated device is configured solely for snow or ice removal, an upper NME layer 507b and one or more associated layers (e.g., a protective film and/or encapsulant layer 504b disposed above the cell stack) may be omitted to increase optical transmission to the solar cell layer. In such embodiments, the remaining NMEs (e.g., the cell-level NMEs 503b) may be positioned within inter-cell gaps and/or aligned with non-active regions of the module to reduce shading and minimize interference with incident light. In further embodiments, the upper NME layer 507b is provided for dust or debris removal. The upper NMEs 507b may comprise relatively narrow electrode traces arranged to align with front-side metallization features of the solar cells (e.g., fingers and/or busbars) to reduce optical losses. The upper NMEs 507b are preferably disposed near an exterior surface of the module (e.g., on or near a front-side glass layer) such that the resulting electric field is generated proximate the light-receiving surface, thereby improving electrodynamic dust-removal effectiveness.

The arrangement shown in FIG. 5b is advantageous because the nanomaterial electrodes (NMEs) layer 503b configured for snow or ice removal is embedded within the solar panel, between existing module layers, while the nanomaterial electrodes (NMEs) layer 507b configured for dust or debris removal is disposed externally, thereby reducing circuit crossover complexity and simplifying electrical routing. In retrofit configurations, as shown in FIG. 5a, one or more nanomaterial electrode (NME) layers 501a may be disposed on a substrate 502a (e.g., as described with reference to FIG. 1) and retrofitted onto the solar panel 504a as part of a multilayer film structure. As further illustrated in FIG. 5b, one or more adhesive layers may be provided between adjacent labeled components to facilitate lamination, structural integration, and environmental sealing.

Referring now to FIG. 6, shown therein is a perspective view of a typical solar panel 600 illustrating a plurality of fingers 603a, 603b, a plurality of bus bars 602a and 602b, and a plurality of inter-cell gaps 601a and 601b formed between a plurality of active elements 604 of the solar panel 600. The solar panel 600 includes a plurality of active elements 604 configured to receive solar radiation and convert the solar radiation into electrical power. Although a single active element 604 is labeled for clarity, it will be appreciated that the present description applies to the plurality of active elements 604 of the solar panel 600.

As illustrated in FIG. 6, each active element 604 is separated from adjacent active elements by intercell gaps 601a and 601b, which, in one embodiment, have a width of approximately 3 mm. Each active element 604 includes a plurality of fingers 603a, 603b configured to collect generated charge carriers. The fingers 603a and 603b are electrically coupled to one or more bus bars 602a and 602b, which extend across the active element 604 to aggregate electrical current from the fingers 603a and 603b.

As illustrated in FIGS. 5a-5b and FIG. 6, in the selective electrode placement embodiment previously described, the first and second nanomaterial electrodes (NMEs) 503b, 507b may be deposited, for example by conductive ink printing, so as to be disposed within or aligned with the inter-cell gaps 601a, 601b, the bus bars 602a, 602b, and/or the fingers 603a and 603b, thereby reducing coverage of the plurality of active regions of the solar cells 604. By aligning the first and second nanomaterial electrodes (NMEs) 503b, 507b with the preexisting non-active or conductive features of the solar panel 600, the dual-function device 500 may be retrofitted to the solar panel 600 to materially reduce optical transmission or electrical efficiency.

In an embodiment, different electrode layout strategies may be employed depending on the intended functionality and the specific configuration of the solar panel 600. For example, electrode layouts optimized for dust removal may emphasize electrostatic field generation, whereas electrode layouts optimized for snow or ice removal may emphasize resistive heating performance. Such layouts may be tailored based on environmental conditions and installation requirements.

In a preferred embodiment, the first and second nanomaterial electrode (NME) layers 503b, 507b are positioned differently relative to the solar panel stack. The NME layer 503b, configured for snow or ice removal (e.g., resistive heating), is disposed within a laminate region 504b between layers of the solar panel and is therefore preferably positioned in non-active regions so as to reduce shading of the active elements 604. For example, the NME layer 503b may be disposed within, aligned with, or routed through the negative space defined by inter-cell gaps 601a, 601b. In contrast, the NME layer 507b, configured for dust or debris removal (e.g., electrodynamic field generation), is disposed on or above a front-side glass layer 505b and is spatially separated from the active elements 604 by the glass layer 505b. In such embodiments, the NME traces of layer 507b may be formed with relatively thin line widths and aligned with preexisting conductive or non-active features of the solar panel, such as the bus bars 602a, 602b and/or fingers 603a, 603b, to reduce optical losses while maintaining electric-field effectiveness proximate the light-receiving surface. In embodiments, one or both NME layers 503b, 507b may be aligned with the negative space defined by inter-cell gaps 601a, 601b, bus bars 602a, 602b, and/or fingers 603a, 603b, and may be disposed immediately adjacent to or between active elements 604. In one manufacturing embodiment, an NME layer is formed in the same layer as, or immediately adjacent to, the active elements 604 and positioned within the negative space defined by the inter-cell gaps 601a, 601b, bus bars 602a, 602b, and fingers 603a, 603b; in another embodiment, an externally disposed NME layer is aligned to the same negative-space features on the front-side surface.

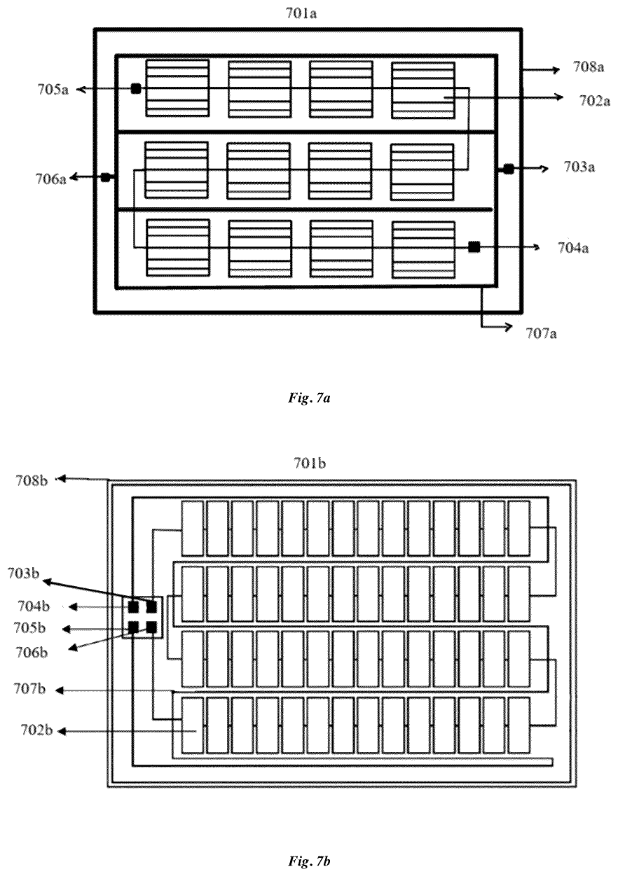

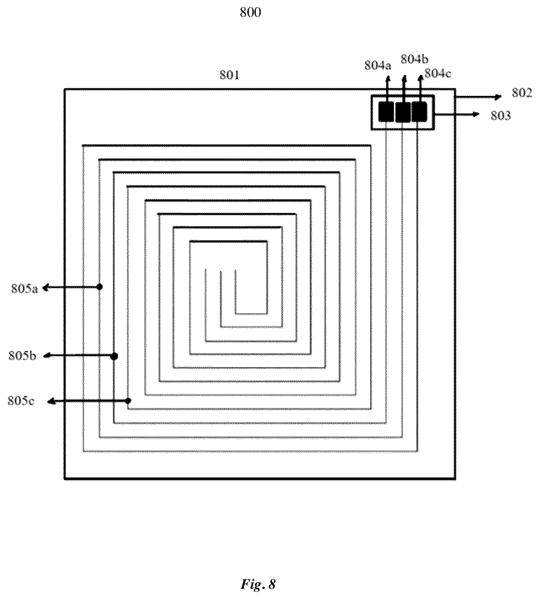

Referring now to FIGS. 7a and 7b, shown therein are top views of a snow removal circuit 702a and 702b respectively integrated into or retrofitted to the solar panel 701a in FIGS. 7a and 701b in FIG. 7b, respectively shown as parallel lines and as series lines, according to respective embodiments.

FIG. 7a illustrates a snow-removal circuit integrated or retrofitted on the solar panel using parallel heating lines in the inter-cell gaps (illustrated as 601a and 601b in FIG. 6) of a dual-function device 700. The parallel heating line or multiple thick heating lines 707a are placed in the inter-cell gaps (illustrated as 601a and 601b in FIG. 6) between solar cells and connected in parallel across the 12V input bus. Each heating line operates quasi-independently, allowing the current per heating line to be controlled and kept well below the safety limit (typically ≤1A per line). The parallel heating lines of the snow-removing circuit in FIG. 7a are attractive for modular control, fault tolerance, and local tuning of heating power.

In one embodiment, snow removal circuit 701a in FIGS. 7a and 701b in FIG. 7b are formed with a thickness greater than that of circuits configured for dust removal. The snow removal circuit 701a in FIGS. 7a and 701b in FIG. 7b may have a thickness in a range of approximately 1 mm to 2 mm and are dimensioned to be disposed of within inter-cell gaps (illustrated as 601a and 601b in FIG. 6) of a solar panel 708a, thereby providing thermal functionality without materially reducing optical transparency of the solar panel.

In one embodiment, for a solar panel 708a having an area of approximately 1 m², the snow removal circuit 701a in FIGS. 7a and 701b in FIG. 7b are configured to generate thermal power in a range of approximately 100 W to 500 W, depending on ambient temperature conditions, such that accumulated snow is melted within a period of several minutes.

In one embodiment, operation of the snow removal circuit 701a in FIGS. 7a and 701b in FIG. 7b is subject to one or more design constraints. The temperature of each snow removal circuit 701a in FIGS. 7a and 701b in FIG. 7b is controlled such that it does not exceed approximately 50° C. above ambient temperature, thereby reducing risk of thermal damage to the solar panel 708a or associated components of the device 100a of the system 100 illustrated in FIG. 1. To comply with this temperature constraint, current supplied to each snow removal circuit 701a in FIGS. 7a and 701b in FIG. 7b is limited to a maximum of approximately 2A.

In FIG. 7a, a junction box is integrated to provide electrical input and output connections for the solar panel. Terminals 703a and 706a provide the DC heating supply (e.g., ~12 V and ground) and are electrically coupled to the heater nanomaterial electrodes (NMEs) 707a, forming a closed circuit for current flow through the heater line. In contrast, the solar power output path is provided via terminals 704a and 705a, which are electrically coupled to the series-connected solar cells 702a to extract the photovoltaic power. In one embodiment, the series-connected heater NMEs 707a are electrically coupled between an input terminal 706a configured to receive a heating supply voltage (for example, approximately 12 V) and a ground terminal 703a, while being electrically isolated from the solar panel output path extending between a positive output terminal 704a and a negative output terminal 705a of the solar panel. A plurality of bus bars collects photovoltaic current from the solar cells 702a independently of the snow-removal/heating circuit 707a. Accordingly, the heater line 707a is electrically isolated from the solar cells 702a and from the corresponding panel power conductors and bus bars.

In one embodiment, the snow removal circuit 701a in FIGS. 7a and 701b in FIG. 7b are configured to operate at a nominal voltage of approximately 12 V, thereby enabling compatibility with external battery power sources and facilitating integration with off-grid or energy storage-based systems.

In one embodiment, a snow-removal circuit is implemented in a series 701b in FIG. 7b in which a single, continuous heating path 707b extends through inter-cell gaps of a solar panel 708b, thereby forming an elongated resistive heating element. In the series circuit, heater nano material electrodes (NMEs) 707b are disposed within the inter-cell gaps between adjacent solar cells 702b and extend across the solar panel 708b in a continuous series path.

In one example embodiment, for a given total heating power, the snow removing circuit in a series configuration operates at a lower current relative to a parallel configuration, while exhibiting higher line resistance and increased conductor length. As a result, a reduced line width of the heater nano material electrodes (NMEs) 707b may be employed while maintaining the at least same surface temperature and power density. The series configuration promotes more uniform distribution of electrical load and thermal energy across the surface of the solar panel 704, thereby reducing localized heating variations.

In FIG. 7b, a junction box is integrated to provide electrical input and output connections for the solar panel. Terminals 704b and 705b provide the DC heating supply (e.g., ~12 V and ground) and are electrically coupled to the heater nanomaterial electrodes (NMEs) 707b, forming a closed circuit for current flow through the heater line. In contrast, the solar power output path is provided via terminals 703b and 706b, which are electrically coupled to the series-connected solar cells 702b to extract the photovoltaic power. In one embodiment, the series-connected heater NMEs 707b are electrically coupled between an input terminal 704b configured to receive a heating supply voltage (for example, approximately 12 V) and a ground terminal 705b, while being electrically isolated from the solar panel output path extending between a positive output terminal 703b and a negative output terminal 706b of the solar panel. A plurality of bus bars collects photovoltaic current from the solar cells 702b independently of the snow-removal/heating circuit 707b. Accordingly, the heater line 707b is electrically isolated from the solar cells 702b and from the corresponding panel power conductors and bus bars.

In one embodiment, energy consumption associated with snow removal is limited relative to the energy gained by restoring solar panel 708b operation. For example, snow removal may consume approximately 50 Wh, corresponding to operation at approximately 300 W for 10 minutes, which represents approximately 3% of the additional energy recovered from a cleared solar panel 708b during a winter operating period, wherein daily energy recovery from a snow-free panel may be approximately 1500 Wh. Accordingly, energy consumed by the snow removal circuit 701a in FIGS. 7a and 701b in FIG. 7b is negligible relative to the net energy gain achieved.

In one embodiment, the series-connected snow-removal circuit 701b may be integrated within the solar panel during manufacture or retrofitted onto an existing solar panel by disposing of the heater nano material electrodes (NMEs) 707b within the inter-cell gaps. The configuration preserves optical efficiency by avoiding coverage of active photovoltaic regions and maintains mechanical integrity by limiting thermal stress and additional material thickness. Both integrated and retrofit embodiments of the series configuration are configured to provide reliable snow and ice removal while consuming minimal additional energy at the system level and without materially degrading electrical performance, optical transmission, or structural durability of the solar panel.

FIG. 8 shown therein is a top view of a dust-removal circuit 801, integrating a power supply circuit, integrated into or retrofitted onto a solar panel 802, according to an embodiment. The dust-removal circuit 801 comprises a three-phase parallel electrode arrangement including phase lines 805a, 805b, and 805c disposed across the surface of the dust-removal film 801.

In one embodiment, the phase lines 805a, 805b, and 805c extend across the solar panel 801 in a repeating pattern so as to cover the active area of the solar panel 801. The phase lines 805a, 805b, and 805c are aligned with conductive features of the solar panel 801 (not illustrated in FIG. 8), including fingers 603a and 603b associated with solar cell 600, as illustrated in FIG. 6. The alignment establishes a spacing of approximately 1 mm between adjacent phase lines, corresponding to the spacing between the fingers 603, for limiting coverage of optically active regions of the solar panel 801.

In one embodiment, the nanomaterial electrodes (NMEs) forming the phase lines 805a, 805b, and 805c have a thickness of approximately 100 micrometers, which can be selected to provide a defined electrode cross-section compatible with the thickness of the fingers 603a and 603b (illustrated in FIG. 6) while enabling electric-field generation.

In one embodiment, the dust-removal film 801 is energized by a multi-phase alternating-voltage source within the PCU 104 (see FIG. 1). The three-phase source is electrically coupled to the dust-removal film terminals 803 via phase inputs 804a, 804b, and 804c. These terminals distribute the applied voltages to the corresponding nanomaterial electrodes (NMEs) 805a, 805b, and 805c, which are electrically open-ended such that no direct current conduction path is formed through the NMEs. Applying the multi-phase alternating voltage generates an electric field between adjacent phase lines, with an electric-field magnitude of approximately 10\hat{ }6 V/m while avoiding sustained conductive current through the nanomaterial electrodes (NMEs). The generated electric field induces electrostatic charging of dust particles located on the surface of the dual-function electrodynamic retrofit film (DFERF) and produces electrostatic forces that displace the charged dust particles from the surface of the solar panel 801. The three-phase parallel configuration provides electric-field coverage across the surface of the solar panel 801 corresponding to the nanomaterial electrodes (NMEs) layout. In one embodiment, a single dust-removal operation consumes approximately 5 Wh of electrical energy.

In various embodiments, the dual-function electrodynamic retrofit film (DFERF) is configured to provide both dust removal and snow or ice removal using a common nanomaterial electrodes (NMEs) architecture and power and control unit (PCU). In a first implementation, one of the existing thin electrodynamic three-phase nanomaterial electrodes (NMEs) is selectively reconfigured between an open-ended, high-voltage alternating-current mode for electrodynamic dust removal and a closed-loop, low- or medium-voltage direct-current mode for resistive snow melting, resulting in four electrical terminals between the dual-function electrodynamic retrofit film (DFERF) and the PCU and reduced additional printed features at the expense of increased switching complexity within the PCU. In a second implementation, a separate set of thick heater nanomaterial electrodes (NMEs) are printed and aligned with busbars or inter-cell gaps and coupled to dedicated terminals, resulting in five electrical terminals between the DFERF and the PCU and a simplified, electrically independent low-voltage heater circuit suitable for higher-current operation. In both implementations, heater-based nanomaterial electrodes (NMEs) are aligned with non-transparent regions of the solar panel to preserve optical efficiency, and a single effective resistive loop for snow melting. The thin-line implementation provides more spatially uniform heating with lower wiring losses due to reduced current, while the thick-line implementation provides higher local power density and simpler control. Both implementations enable year-round dual-mode operation and reducing added material, wiring, and energy consumption.

In one embodiment, FIG. 9a (related to second implementation in last part) illustrates a dual-function electrodynamic retrofit film (DFERF) 901a is implemented as a dual-function two-layer circuit 900a comprising a first circuit configured for snow or ice removal and a second circuit configured for dust removal. The two circuits are electrically distinct and vertically separated to optimize their respective operating principles. Referring now to FIG. 9a, shown therein is a schematic view of a dual-function two-layer circuit 900A formed within the dual-function electrodynamic retrofit film (DFERF) 901a. The circuit 900a includes a plurality of electrical input terminals 911a comprising a heater electrode input terminal 906a configured to receive a direct-current heating voltage, a plurality of phase input terminals 907a, 908a, 909a corresponding to phase A, phase B, and phase C of a high-voltage alternating-current source, and a heater electrode ground terminal 910a.

Furthermore, the circuit 900a includes heater nanomaterial electrodes (NMEs) 902a disposed in a first layer and configured to generate resistive heating when energized by a low-voltage direct-current supply, and dust-removal nanomaterial electrodes (NMEs) 903a, 904a, 905a disposed in a second layer and configured to generate electrodynamic fields when energized by a multi-phase high-voltage alternating-current source. In one embodiment, the heater nanomaterial electrodes (NMEs) 902a and dust-removal nanomaterial electrodes (NMEs) 903a, 904a, 905a are printed using conductive materials and electrically isolated from one another by an intervening dielectric layer. The dust-removal nanomaterial electrodes (NMEs) 903a, 904a, 905a are disposed in the upper layer of the dual-function electrodynamic retrofit film (DFERF) 901a to reduce the distance between the nanomaterial electrodes (NMEs) 903a, 904a, 905a and dust particles located on the surface of the dual-function electrodynamic retrofit film (DFERF) 901a, for effective electric-field generation for electrostatic dust removal.

FIG. 9b is a schematic view of the dual-function two-layer circuit 900b integrated into or retrofitted onto a dual-function electrodynamic retrofit film (DFERF) 901b. The dust-removal electrodes 913b,914b,915b are positioned on a top layer of the dual-function electrodynamic retrofit film (DFERF) 901b and aligned relative to the solar panel surface, and the heater nanomaterial electrodes (NMEs) 902b are disposed in a lower layer closer to one or more non-active regions of the solar cells 904b, including busbars 903b and inter-cell gaps.

As illustrated in FIG. 9b The dual-function electrodynamic retrofit film (DFERF) 901a includes five electrical output connections in addition to two photovoltaic output terminals 907b, 908b that capture electrical power generated by the solar cells 904b through the power line 903b. Three of the output connections correspond to the phase input terminals 913b, 914b, 915b for the dust-removal system and are electrically coupled to a high-voltage three-phase alternating-current source. Two additional input connections correspond to the heater nanomaterial electrode (NMEs) input and the input terminals 906b, 909b and are electrically coupled to a low-voltage direct-current source, for example approximately 12 V, for snow or ice removal.

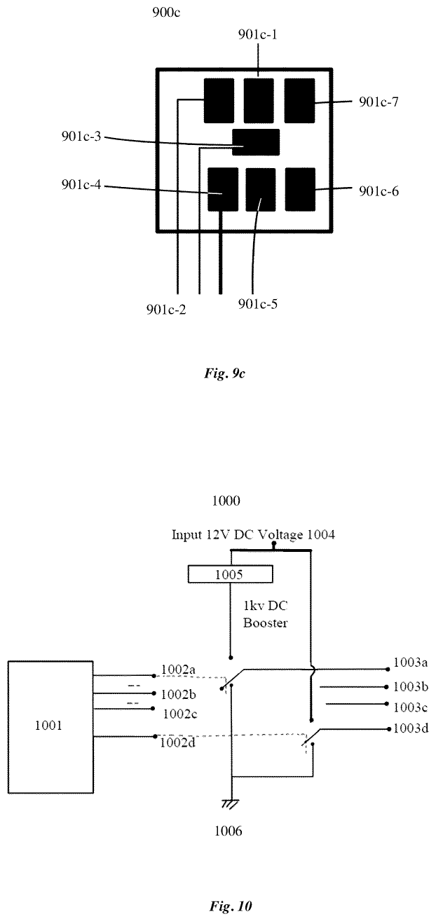

In one embodiment, conversion of the low-voltage direct-current supply to a high-voltage three-phase alternating-current supply for dust removal is performed within a centralized power and control unit (illustrated in FIG. 10). The power and control unit may be mounted to a rear surface of the solar panel and powered by an external battery or other energy source.

In an example embodiment, one or more additional sensors are integrated into the dual-function electrodynamic retrofit film (DFERF) 900b, one or more additional electrical outputs may be provided for sensor data transmission, with all electrical connections routed to the centralized power and control unit. In an embodiment, depending on deployment conditions, the dual-function two-layer circuit 900a and 900b may be configured to provide one of the two functionalities. In climates where snow or ice accumulation is not expected, the heating layer may be omitted, leaving the dust-removal layer. In an alternative embodiment, in environments where dust accumulation is less, the dust-removal layer may be omitted, leaving the heating layer. The modular architecture allows the system to be tailored to specific environmental conditions without altering the underlying solar panel structure.

Referring now to FIGS. 9a and 9b, shown therein is a schematic view of a dual-function two-layer circuit 900a, according to an embodiment, and the snow removal circuit further integrated into or retrofitted to the dual-function electrodynamic retrofit film (DFERF), according to an embodiment. The circuit 900 combines the snow and dust removal functionalities into a single apparatus across two layers, such that the snow removal functionality and the dust removal functionality are electrically isolated from one another.

In a preferred embodiment, the dust removal circuit 907a,908a,909a in FIGS. 9a and 913b,914b,915b in FIG. 9b has a thickness of approximately 100 micrometers, and the snow removal circuit 906a in FIGS. 9a and 906b in FIG. 9b has a thickness of approximately 1 mm.

Referring now to FIG. 9b, shown therein is a dual-function two-layer circuit 900B integrated into or retrofitted onto a solar cell 904b and aligned with the fingers on the cells 905b. In this embodiment, the dual-function electrodynamic retrofit film (DFERF) includes a plurality of electrical output connections coupled to a centralized power and control unit. Specifically, the film includes five output connections in addition to two photovoltaic output terminals 907b, 908b configured to deliver electrical power generated by the solar panel. A first pair of output terminals 901b, 905b is dedicated to a snow-removal heating circuit and is configured to receive a low-voltage direct-current supply, for example, approximately 12 V, wherein terminal corresponds to a heater input voltage and terminal corresponds to a heater ground. The heating circuit energizes heater electrodes, which are configured to generate resistive heating for snow or ice removal.

Further, a second set of three-phase input terminals is dedicated to a dust-removal circuit and corresponds to phase A, phase B, and phase C inputs of a high-voltage three-phase alternating-current source. These terminals are electrically coupled to dust-removal electrodes, which are disposed in an upper layer of the dual-function electrodynamic retrofit film (DFERF) to generate electrodynamic fields for electrostatic dust removal. The two-layer circuit is electrically isolated from the photovoltaic output path of the solar panel, which is routed via positive and negative photovoltaic output terminals. The photovoltaic current is collected from solar cells 904b via fingers 905b and busbars 903b.

In one embodiment, conversion of the low-voltage direct-current supply provided to the output terminals into a high-voltage three-phase alternating-current supply for the dust-removal circuit is performed within a centralized power and control unit. All electrical connections from the film, including the output terminals and photovoltaic output terminals, are routed to the centralized power and control unit, which may be mounted to the rear surface of the solar panel and powered by an external battery.

In embodiments in which additional sensors are integrated into the film, additional output terminals may be provided for sensor signal transmission, and such terminals are likewise routed to the centralized power and control unit.

Depending on the environmental conditions in which the system is deployed, the dual-function film may be simplified by omitting one of the two functional layers. In environments where snow or ice accumulation is not expected, the heating layer and the output terminals may be omitted. In an alternative embodiment, in environments where dust accumulation is less, the dust-removal layer and corresponding phase input terminals may be omitted, while retaining the remaining functionality.

FIG. 9c is a schematic view of a junction box 900c as shown in FIG. 9b, in accordance with embodiments of the present disclosure. Referring to FIG. 9c, a compact terminal block 900c consolidates the distributed edge terminals of FIGS. 9a-9b into a single connector interface while providing equivalent functionality. The contact pads 901c-2 and 901c-5 correspond to the low-voltage DC input and return for snow-removal heating, contact pads 901c-3, 901c-4, and 901c-6 correspond to the three-phase alternating current (AC) inputs for electrodynamic dust removal, and contact pad and 901c-1 corresponds to a photovoltaic output or auxiliary connection. Internal routing within the block electrically couples each pad to its corresponding electrodes or photovoltaic (PV) output in the film. Mode selectivity is preserved: during heating, only pads 901c-2/901c-5 are energized while phase pads 901c-3,901c-4,901c-6 are isolated; during dust removal, the phase pads are energized while the heating pads are isolated.

According to FIG. 10, shown therein is a schematic diagram of a control circuit and power source 1000 configured to operate a dual-function film providing both dust-removal and snow-removal functionality, according to an embodiment. The control circuit and power source 1000 includes a control unit 1001, a high-voltage direct current DC booster 1005, an external low-voltage DC input 1004, a plurality of controlled switching elements 1002a-1002d, a plurality of output terminals 1003a-1003d, and a ground reference 1006. The control signals 1002a-1002d drive corresponding switches that selectively route the desired voltage levels to the output terminals 1003a-1003d. The output terminals 1003a-1003d are electrically coupled to the terminals 911a of the DFERF 901a (see FIG. 9a). In one embodiment, outputs 1003a-1003c are coupled to the three dust-removal phase terminals 907a-909a (see FIG. 9a), while output 1003d is coupled to the snow-removal DC terminal 906a (see FIG. 9a).

In one embodiment, the system receives an external low-voltage direct-current input, for example, approximately 12 V DC, at external low-voltage DC input 1004. This low-voltage input is supplied to the DC booster 1005, which is configured to elevate the voltage to a high-voltage direct-current level, for example, approximately 1 kV DC, suitable for electrodynamic operation and selective heating as described herein. In one embodiment, the control unit 1001 dynamically reconfigures nanomaterial electrode (NMEs) terminals to apply high-voltage AC for dust removal and low- or high-voltage DC for snow melting using a MOSFET or relay-based switching matrix, while enforcing isolation to prevent AC and DC cross-conduction.

In an embodiment, the boosted high-voltage DC output is selectively routed through a set of switching elements controlled by the control unit 1001. In the illustrated embodiment, the plurality of controlled switching elements 1002a-1002c correspond to independently controllable phase paths, while switching element 1002d provides a DC voltage 1004 for the output 1003d. Under the control of the power and control unit 1001, the plurality of controlled switching elements 1002a-1002c are actuated in a timed sequence to generate phase-shifted voltage waveforms at output terminals 1003a, 1003b, and 1003c. When operated in a dust-removal mode, these outputs supply phase-controlled voltages to the dust-removal electrodes, thereby producing the alternating electric fields required for electrodynamic dust removal. In one embodiment, the controller switches each phase at a frequency in a range of 1 Hz to 10 Hz.

In addition to controlling dust-removal operation, the control unit 1001 is further configured to control snow-removal heating operation. In this mode, the control unit selectively connects the output terminals 1003d, to the the 12V dc input 1004 via switch 1002d, while simultaneously connecting an opposing terminal to the ground reference 1006, thereby forming a closed conductive path through a designated heating electrode. This configuration allows a direct current to flow through the heating electrode to generate resistive heat for snow and ice removal.

The power and control unit 1001 determines which of the plurality of controlled switching elements 1002a-1002d are enabled or disabled based on a selected operating mode, such that dust-removal operation and snow-removal operation are mutually exclusive. This mode-based switching prevents simultaneous application of alternating electric-field excitation and resistive heating current on the same conductors, ensuring electrical isolation and safe operation.

Accordingly, the embodiment illustrated in FIG. 10 provides a centralized power and control unit that cooperates with the electrode-level switching described with respect to FIG. 9, enabling selective generation, routing, and control of high-voltage phase-controlled signals for electrodynamic dust removal and direct-current power for resistive snow removal using a common low-voltage DC input and a shared control unit.

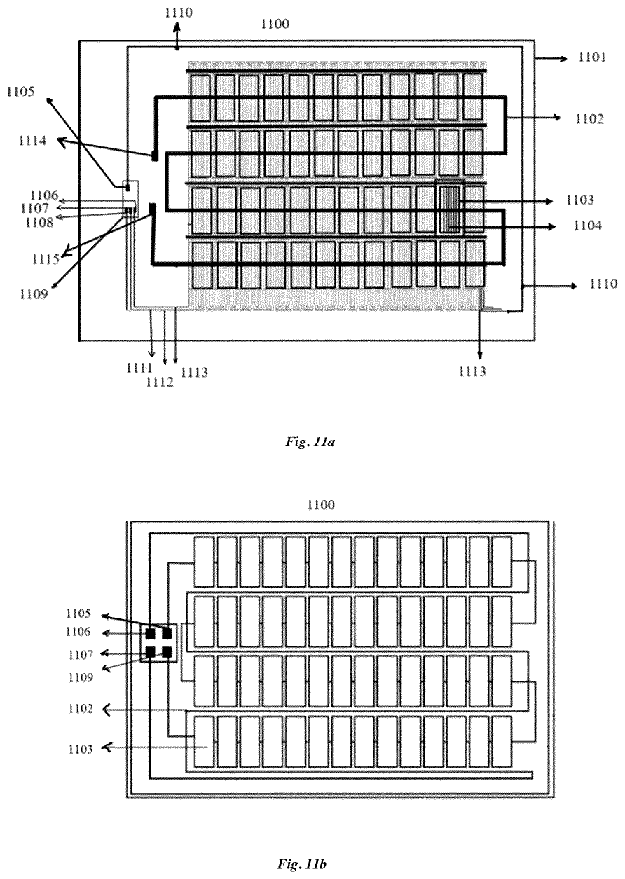

Referring now to FIG. 11a, shown therein is a top view of the dual-function one-layer circuit 1100 integrated into the solar panel 1101, according to an embodiment. In the one-layer dual-function circuit 1100, the dust and snow removal functionalities are combined into a single circuit, using three parallel nanomaterial electrodes (NMEs) 1111, 1112, 1113 that cover the entire surface of the solar panel 1101. Two of the parallel nanomaterial electrodes (NMEs) 1111, 1112 are open-ended, connecting to port 1107 and 1108 in the terminal to the junction box 1109 at inputs to receive the AC input, while the third nanomaterial electrode (NME) 1113 connects to the junction box 1109 at 1106 to receive the AC input in the dust removal functionality and the 1 kV DC input in the snow removal functionality. The end point of NME 1113 again connects to junction box 1109 at the port 1105 via wire 1110 within the snow removal system to receive a 0 V input. It is always connected to the port, and during snow removal, it receives zero voltage, enabling parallel electrode 1113 to carry a DC current for heating. In contrast, during dust-removal operation, the connection associated with port 1105 is placed in an open-circuit (high-impedance) state such that the end point of the NME 1113 is left floating (open-ended) and does not receive an applied voltage.

FIG. 11a illustrates the nanomaterial electrode (NME) 1113 further connected to the junction box 1109 at 1105 to receive a 0 V DC input to complete the circuit. For greater clarity, the remaining two nanomaterial electrodes (NMEs), 1111, 1112, are open-ended and are disconnected from the junction box 1114 beyond the AC inputs received at ports 1107, 1108. The one-layer dual-function circuit 1100 supports both functionalities by carefully managing input voltage and control switching.

When the one-layer dual-function circuit 1100 performs the dust removal functionality, the three-phase AC voltage is applied to the three parallel nanomaterial electrodes (NMEs) 1111, 1112, 1113, all of which are open-ended in the dust removal phase or functionality, as the connection of the nanomaterial electrode (NME) disconnects from the junction box 1109 such that the third nanomaterial electrode (NME) 1113 is no longer connected to 0V voltage, thereby creating the electric field for dust removal via electrostatic force. When one-layer dual-function circuit 1100 performs the snow removal functionality, the nanomaterial electrode (NME) 1113 is connected to a DC voltage input, allowing a DC current to flow through the electrode 1113 and generate heat.

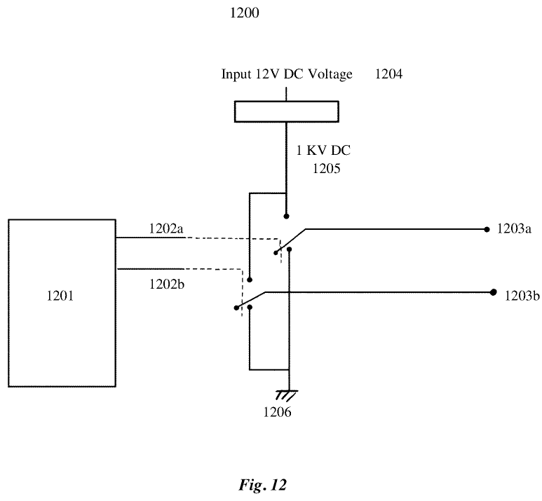

In a preferred embodiment, the heating nanomaterial electrode (NME) is 100 micrometers thick, and the length of dual-function nanomaterial electrode (NME) 1113 is approximately 150 times longer than the heating electrode in the dual-function two-layer circuit 902b in FIG. 9b. The current procedure for the nanomaterial electrode (NME) 1113 is limited to 50 mA to prevent the temperature from rising more than 50° C. above the ambient temperature. The nanomaterial electrode (NME) 1113 may have a resistance of up to 1-10 kOhms when performing the snow removal functionality. To generate the desired power to melt snow and ice, the DFERF of the 1100 receives a DC voltage of approximately 1 kV. Within the control circuit 1201 of FIG. 12, the 12V DC from the power source 1204 has already been stepped up by a DC booster 1205 to a high-voltage DC level before being converted to AC for dust removal. This high-voltage DC may be directly used for the heating functionality, reducing the need for additional components.

It will be appreciated that the connections shown in FIG. 11a about the junction box 1114 physically exist in the DFERF film 1100. The connections are mediated by switches in the PCU unit that connects to the junction box 1109, as further discussed with respect to FIG. 12. As both dust and snow removal functionalities share the dual-function one-layer circuit 1102, the control circuit 1201 accordingly switches between the inputs using an integrated switching mechanism. Accordingly, the DFERF may advantageously alternate between applying AC voltage for dust removal and DC current for heating, depending on the dust removal mode or snow removal mode or the chosen functionality. The photovoltaic current is collected from solar cells 1103 via fingers 1104 and busbars.

In an example embodiment, various key advantages of the one-layer embodiment include a more straightforward design, reducing manufacturing complexity and material costs, and uniform heat distribution, as the thin lines covering the entire surface of the solar panel 1101 cause the heat to be distributed more uniformly during snow removal, leading to more efficient ice melting and clearing of the solar panel 1101. FIG. 11b is a top view of a snow removal one-layer circuit 1100 integrated into the solar panel 1101 according to an embodiment. The snow-removal one-layer circuit 1100 is printed directly onto the top layer of the solar panel 1101.

In reference to previous embodiments, the several advantages of the embodiment include providing for snow removal without adding an extra layer to the DFERF of the solar panel 1101, for simplifying manufacturing. The one or more advantages further include embedding the parallel nanomaterial electrodes (NMEs) 1111, 1112, 1113 within the existing layers of the DFERF of the solar panel 1101 for avoiding loss of transparency for the solar panel 1101. When the solar panel 1101 is planned to be snow-free, the parallel nanomaterial electrodes (NMEs) 1111, 1112, 1113 do not affect the light transmission through the solar panel 1101. The junction box 1109 shown in FIG. 11a and FIG. 11b further includes one or more input/output power connections 1114, 1115 for receiving power from the solar panel bus bars 1102, and 1105, 1106, 1107, 1108 for providing power to DFERF.

FIG. 12, shown therein, is a schematic representation of a power and control circuit 1201 and an associated power source 1204 configured to operate a one-layer dual-function circuit 1100 integrated into a solar panel 1101 (illustrated in FIG. 11a), according to an embodiment. The power and control circuit 1201 is configured to independently control each of a plurality of parallel nanomaterial electrodes (NMEs) 1111, 1112, and 1113 (illustrated in FIG. 11a) disposed across the surface of the solar panel 1101.

In this embodiment, at least one of the nanomaterial electrodes (NMEs), for example, the parallel electrode 1113, is selectively operable in both a dust-removal mode and a snow-removal mode through controlled switching between alternating-current and direct-current excitation. During dust-removal operation, the electrode 1113 is energized by an alternating-voltage signal generated by the power and control circuit 1201, and an end of the electrode 1113 remains electrically open for preventing formation of a closed conductive path and enabling generation of an electrostatic field for dust removal.

During snow-removal operation, the parallel nanomaterial electrode (NME) 1113 is electrically coupled to a high-voltage direct-current output generated by a DC booster 1205, which boosts a low-voltage input supplied by the power source 1204 to a direct-current level of approximately 1 kV DC. In the snow removal mode, a corresponding return connection to a ground reference 1206 is enabled to complete a closed circuit and allow current to flow through the electrode 1113, thereby generating resistive heating.

In a preferred embodiment, the plurality of parallel nanomaterial electrodes (NMEs) 1111, 1112, 1113 are selectively connectable to one or more voltage sources via switching elements disposed at one or more ends thereof. In the illustrated embodiment, the NMEs 1111 and 1112 each require a single switching element configured to selectively couple a respective electrode to either (i) a ground reference (e.g., 0 V) or (ii) a high-voltage (HV) drive line (e.g., an AC travelling-wave drive) depending on an operating mode. In contrast, the NME 1113 is coupled to the junction box at both ends, via terminals 1105 and 1106 (see FIG. 11a), to enable dual-mode operation. In the illustrated embodiment, electrical connection points 1203a and 1203b correspond to the two ends of the NME 1113 at terminals 1105 and 1106, respectively, and control switches 1202a and 1202b are configured to control coupling of the respective connection points 1203a, 1203b. During dust-removal operation, control switch 1202a is actuated to apply an alternating-voltage signal to a first end 1203a of the NME 1113, while control switch 1202b maintains the opposite end 1203b in an open-circuit state such that the electrode is open-ended. During snow-removal operation, control switch 1202a maintains a connection between the first end 1203a of the NME 1113 and a high-voltage direct-current output of the DC booster 1205, and control switch 1202b couples the opposite end 1203b of the NME 1113 to the ground reference 1206 to establish a steady current path through the electrode for resistive heating.

In an example embodiment, the embodiment illustrated in FIG. 12 enables a single-layer nanomaterial electrode (NME) network to selectively operate in an electrodynamic dust-removal mode or a resistive snow-removal mode. This is achieved through controlled switching of voltage sources and circuit topology. The configuration allows independent control of each nanomaterial electrode (NME) in the nanomaterial electrode (NME) network. The independent control is performed using a centralized power and control circuit and power source.

In the preferred embodiment, as illustrated in FIG. 11a, a single, one-layer electrode circuit is configured to perform both electrodynamic dust removal and resistive snow removal through controlled switching of input voltages. The circuit includes three thin, parallel nanomaterial electrodes (NMEs) extending across the surface of the solar panel. In a dust-removal mode, a multi-phase alternating voltage is applied to the nanomaterial electrodes (NMEs) while their distal ends remain electrically open, for generating a non-contact electric field above the solar panel surface that removes dust via electrostatic forces. In a snow-removal mode, one selected nanomaterial electrode (NME) is reconfigured by connecting one end to a high-voltage direct-current source and the opposite end to a ground reference, forming a closed path that produces controlled resistive heating for melting snow and ice. The direct-current heating voltage is derived from the same power and control unit used for dust removal, which selectively switches between alternating-current and direct-current operation such that the two modes are mutually exclusive. The one-layer configuration reduces manufacturing complexity and material usage while providing uniform heating and effective dust removal using a common electrode network and control architecture.

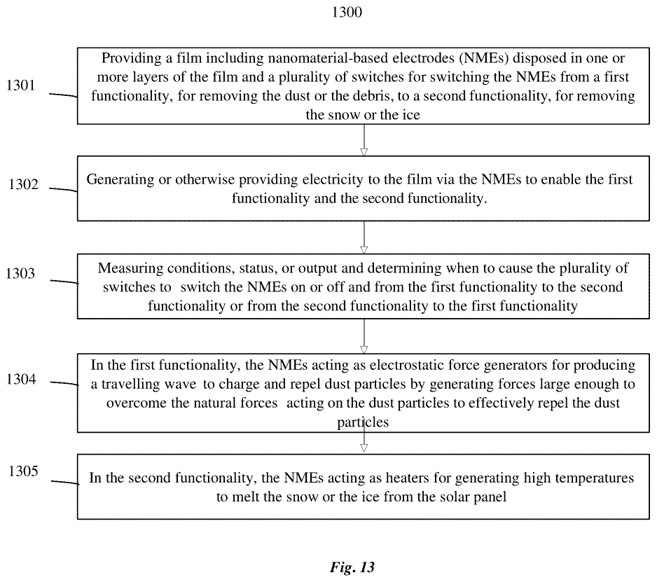

Referring now to FIG. 13, shown therein is a flow diagram of a method 1300 of dust or debris removal and snow or ice removal on a solar panel, according to an embodiment. At 1301, the method 1300 includes providing a dual-function electrodynamic retrofit film (DFERF) including nanomaterial electrodes (NMEs) disposed in one or more layers of the film and a plurality of switches for switching the NMEs from a first functionality, for removing the dust or the debris, to a second functionality, for removing the snow or the ice. At 1302, the method 1300 includes generating or otherwise providing electricity to the dual-function electrodynamic retrofit film (DFERF) via the nanomaterial electrodes (NMEs) to enable the first functionality and the second functionality.

At 1303, the method 1300 includes measuring conditions, status, or output and determining when to cause the plurality of switches to switch the nanomaterial electrodes (NMEs) on or off and from the first functionality to the second functionality or from the second functionality to the first functionality. At 1304, the method 1300 includes, in the first functionality, the NMEs acting as electrostatic force generators for producing a travelling wave to charge and repel dust particles by generating forces large enough to overcome the natural forces acting on the dust particles to effectively repel the dust particles. The force to be generated by the NMEs is given by:

$$\vec{F} = q \vec{E} - \frac{{q}^{2}}{16 {πϵ}_{0} {ϵ}_{s} {r}^{2}} + 4 {πϵ}_{0} {r}^{3} \frac{{ϵ}_{p} - 1}{{ϵ}_{p} + 2} ∇ \vert E {\vert}^{2}$$

where q is the charge of the dust particle and where E is the electric field.

At 1305, the method 1310 includes, in the second functionality, the NMEs acting as heaters for generating high temperatures to melt the snow or the ice from the solar panel. The DFERF is configured to use a negligible amount of output of the solar panel or an integrated battery to perform the first functionality and the second functionality.

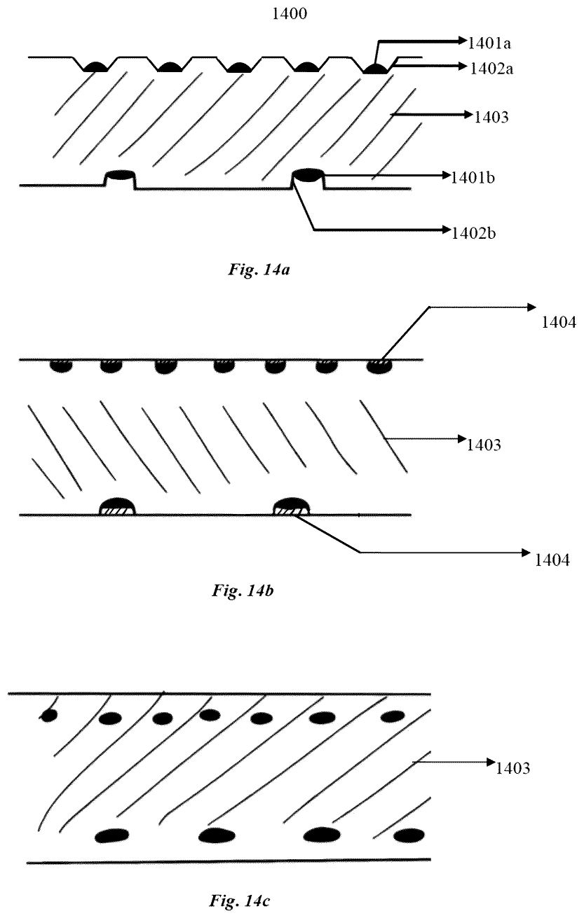

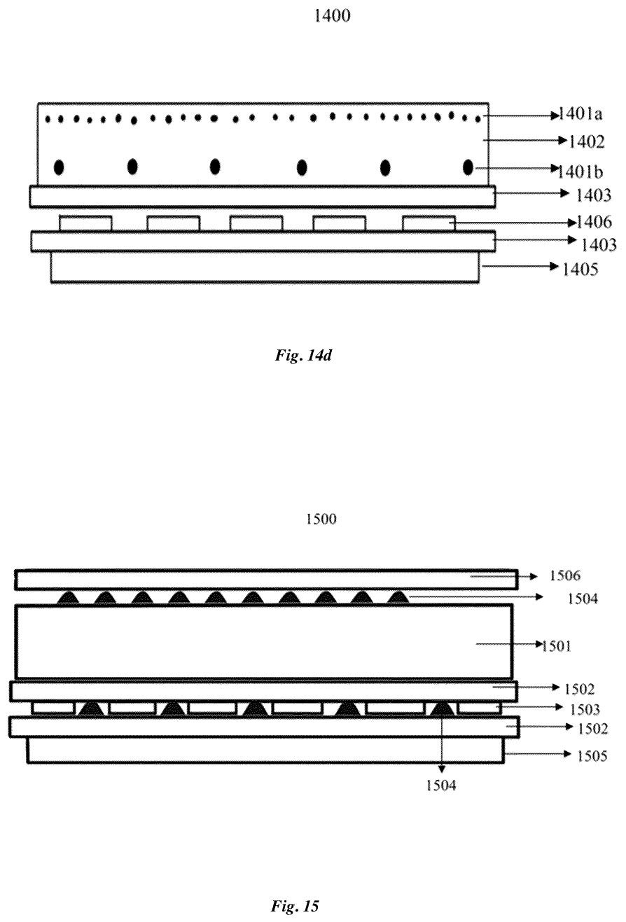

Referring now to FIG. 14a, FIG. 14b, and FIG. 14c, shown therein are sectional views of another embodiment of a dual-function device 1400 for dust or debris removal and snow or ice removal about a solar panel, wherein the dual-function electrodynamic retrofit film (DFERF) functionality is integrated during photovoltaic-module manufacturing by forming nanomaterial electrodes (NMEs) on and/or within a front glass layer 1403 of the solar panel. The dual-function device 1400 may be implemented in a full-surface coating embodiment or a selective coating/placement embodiment.

The dual-function device 1400 includes a plurality of upper nanomaterial electrodes (NMEs) 1401a for dust or debris removal and a plurality of lower electrodes 1401b for snow or ice removal. The plurality of nanomaterial electrodes (NMEs) 1401a and 1402b, respectively, are disposed within upper grooves 1402a and lower grooves 1402b. In FIG. 14b, the dual-function device 1400 includes a liquid dielectric coating 1404 disposed above the plurality of upper nanomaterial electrodes (NMEs) 1401a and below the plurality of lower nanomaterial electrodes (NMEs) 1401b. In a preferred embodiment, the liquid dielectric coating 1404 can be silicon dioxide, but is not restricted to. The liquid dielectric coating 1404 is cured in place to provide electrical insulation, i.e., to electrically isolate the upper electrodes 1401a and the lower electrodes 1401b from one another. The entire glass 1403 is further cured and surfaced. The result of the curing is shown in FIG. 14c.

In the embodiment shown in FIG. 14a, FIG. 14b, FIG. 14c, the plurality of nanomaterial electrodes (NMEs) 1401a and 1401b are directly integrated into the glass 1403 itself, which forms the top layer of the solar panel, creating a specialized glass with the nanomaterial electrodes (NMEs) 1401 (i.e., the device 1400). The said specialized glass may further be used in the solar panel manufacturing process. By embedding the dust and snow removal electrodes 1401a and 1401b into the glass 1403, the resulting dual-function device 1400 simplifies the integration of the first and second functionalities into the solar panel. The glass 1403, with all layers pre-installed, may be provided directly to solar panel manufacturers, who advantageously may not handle additional layers or circuits during assembly of the solar panel, making the production process (after the dual-function device 1400 is assembled) nearly identical to that of a regular solar panel, with elements such as placement of the active elements 1406 (illustrated in FIG. 14d) and attachment of a back sheet 1405 (illustrated in FIG. 14d) substantially unchanged.

Referring now to FIG. 14d, shown therein is a side sectional view of a complete solar panel, with the dual-function device 1400 installed therein, according to an embodiment. Like numerals denote references with respect to FIG. 14a-14c.

FIG. 15 is a schematic diagram of a dual-function, two-layer system 1500 integrated into the panel with internal snow removal heaters in the inter-cell gaps and a DFERF dust-removal layer near the front glass 1501.

Referring now to FIG. 15, a cross-sectional view of a dual-function, two-layer system 1500 is shown, incorporating a selective coating to improve optical transparency while enabling both dust-removal and snow-removal functionality. As illustrated, the system 1500 includes a tempered glass layer 1501, which forms the outer protective surface of the photovoltaic module. Disposed on or immediately above the tempered glass layer 1501 is a patterned electrode layer 1504, configured to operate as an electrodynamic retrofit film for dust-removal functionality. In accordance with the selective coating embodiment, the electrode layer 1504 may be covered by (i) a continuous encapsulating film or coating 1506, or (ii) a selective protective coating applied locally over the electrode traces. In an example embodiment, a protective coating is applied over the electrode traces to protect the conductive material while leaving intervening regions of the glass layer 1501 substantially uncoated, thereby reducing additional optical interfaces and improving optical transmission. In other embodiments, the protective film or coating extends continuously across the surface to encapsulate the electrode layer 1504. Further, below the tempered glass layer 1501, the photovoltaic conversion structure is disposed. Specifically, one or more solar cells 1503 are encapsulated between adhesive layer 1502 such as EVA layers, which provide mechanical bonding, electrical insulation, and environmental protection. In this region, additional electrode layer 1504 may be integrated within optically inactive regions, such as inter-cell gaps, to function as snow-removal heating elements. These heating electrodes are configured to generate resistive heat when energized, thereby enabling snow or ice melting without introducing additional opaque layers above the active solar area. Furthermore, the system 1500 further includes a back sheet 1505 disposed beneath the lower protective coating 1502 such as EVA layer, providing structural support and environmental sealing for the rear side of the module.

In this embodiment, the selective application of the protective coating 1506 over the electrode layer 1504 allows the dust-removal electrodes to remain protected from abrasion and environmental exposure while avoiding full-surface lamination that would otherwise reduce optical transmission. At the same time, the integration of heating electrodes layer 1504 within the lower encapsulated regions enables snow-removal functionality without compromising the transparency of the module.

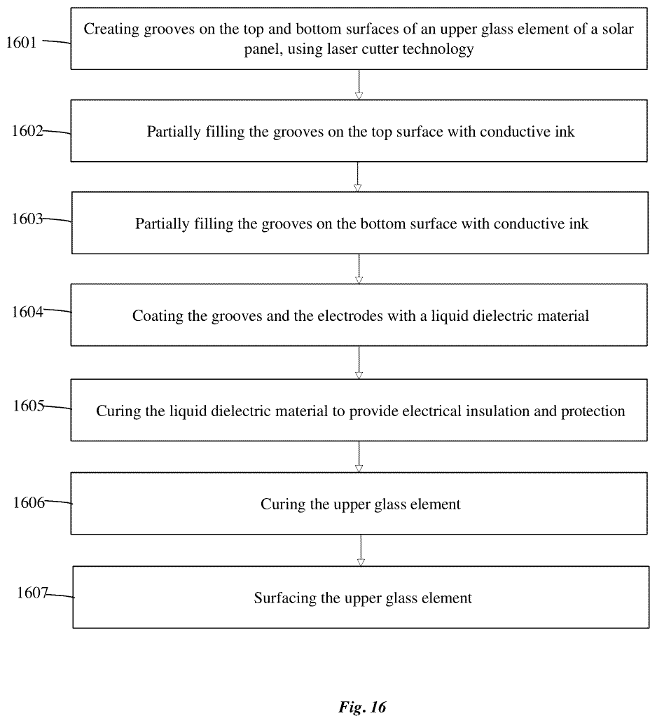

FIG. 16 illustrates a method 1600 of assembling the dual-function device 1400 of FIG. 14a, FIG. 14b, FIG. 14c according to an embodiment. At 1601, the method 1600 includes creating grooves on the top and bottom surfaces of an upper glass element of a solar panel, using laser cutter technology. The grooves are in or above the gaps, the bus bars, or the fingers such that the grooves do not cover the active elements. At 1602, the method 1600 further includes partially filling the grooves on the top surface with conductive ink to form a first subset of the NMEs configured to act as electrostatic force generators for producing a travelling wave to charge and repel dust particles by generating forces large enough to overcome the natural forces acting on the dust particles to effectively repel the dust particles, wherein the force to be generated by the upper plurality of NMEs is given by:

$$\vec{F} = q \vec{E} - \frac{{q}^{2}}{16 {πϵ}_{0} {ϵ}_{s} {r}^{2}} + 4 {πϵ}_{0} {r}^{3} \frac{{ϵ}_{p} - 1}{{ϵ}_{p} + 2} ∇ \vert E {\vert}^{2}$$

wherein q is the charge of the dust particle and wherein E is the electric field.

Space is left in the grooves for further coatings.

At 1603, the method 1600 further includes partially filling the grooves on the bottom surface with conductive ink to form a second subset of the NMEs configured to act as heaters for generating high temperatures to melt the snow or the ice from the solar panel. Space is left in the grooves for further coatings. At 1604, the method 1600 includes coating the grooves and the nanomaterial electrodes (NMEs) with a liquid dielectric material. The liquid dielectric material may be silicon dioxide. At 1605, the method 1600 includes curing the liquid dielectric material to provide electrical insulation and protection. At 1606, the method 1600 includes curing the upper glass element. At 1607, the method 1600 includes surfacing the upper glass element. Surfacing the upper glass element may include smoothing or shaping the upper glass element.

In one example embodiment, the dual-function electrodynamic retrofit film (DFERF) providing dust removal and snow removal functionality is deployable either as a retrofit applied to existing photovoltaic PV modules or as an integrated component within a PV manufacturing process. In a retrofit configuration, the DFERF is laminated or bonded onto deployed modules to upgrade performance in environments subject to dust accumulation or snow and ice. In an integrated configuration, the DFERF is incorporated into the module laminate stack or onto an inner surface of the front glass during manufacture, thereby improving thermal coupling of snow removal heaters, reducing required deicing power, and fully encapsulating electrodes and interconnects for enhanced mechanical robustness and long-term reliability. Manufacturing level integration further eliminates on site installation steps, enables factory installed wiring and connectors at junction box regions, and allows additional conductors to be provided with proper insulation and strain relief. By amortizing DFERF materials and processing over high volume production, integrated manufacturing yields a scalable cost structure relative to retrofit approaches. Accordingly, embodiments include integration of the DFERF into PV manufacturing lines, integration of the DFERF into or onto the front glass, and integration of a complete cleaning system including the ERF, power and control electronics, wiring, and sensors into a smart, self-cleaning photovoltaic module.

In one example embodiment, the dual-function electrodynamic retrofit film (DFERF), snow-removal heating elements, sensing components, and a power control unit PCU are integrated as a single smart photovoltaic module, wherein DFERF and heater electrode networks are formed on a film or embedded in a front glass layer and are internally routed by four or five conductors to a junction box on a rear surface of the module that houses the PCU, while the module externally presents positive and negative direct-current output terminals and optionally a low-voltage communication pair. The integrated system includes printed dust-removal and snow-removal electrode networks, optional embedded sensors, and internal wiring terminating within the junction box without additional external connectors and the PCU selectively actuates electrodynamic cleaning or resistive heating while photovoltaic power continues to be delivered through the outputs. The PCU may be powered from a battery in off-grid systems or from a portion of the solar panel own direct-current output in grid-tied or direct-current-coupled systems using internal conversion, without a dedicated external power supply. In further embodiments, the PCU integrates module-level power optimization functions and telemetry, enabling centralized monitoring and control of cleaning operations based on local sensing, power-output analysis, and optionally weather-forecast data. By integrating cleaning, sensing, control, and power management within the junction-box infrastructure, the photovoltaic module operates as a self-maintaining, actively controlled element while preserving conventional installation and wiring practices.

In one embodiment, the dual-function electrodynamic retrofit film (DFERF) configured for dust removal and ice or snow mitigation is applied to a broad range of non-photovoltaic surfaces requiring maintained optical clarity, airflow, thermal performance, or signal integrity. Such surfaces include optical sensors and cameras used in vehicles and advanced driver assistance systems, navigational aids such as lighthouses and maritime beacons, weather and environmental monitoring instruments, telecommunication equipment including antennas and satellite dishes, transportation infrastructure such as road signs and traffic control devices, emergency monitoring equipment deployed in mountainous or forested regions, architectural glass surfaces including windows, facades, and exterior lighting fixtures, and defense-related optical and sensing systems.

In further embodiments, the dual-function electrodynamic retrofit film (DFERF) can be applied to industrial and infrastructure components, including condenser coils, evaporator coils, air intake grills, ventilation ducts, and outdoor Heating, Ventilation, and Air Conditioning (HVAC) units, to reduce ice formation, dust accumulation, and fouling that impair efficiency and reliability. In these applications, the dual-function electrodynamic retrofit film (DFERF) operates in one or more modes comprising electrodynamic particle removal and controlled heating and may be powered by existing electrical systems associated with the host equipment or by a low-power auxiliary source. Accordingly, the electrodynamic cleaning technology is not limited to photovoltaic panels and is adaptable as a self-maintaining surface solution for optical, sensing, infrastructure, industrial, transportation, and defense systems operating in environments subject to dust, ice, snow, or debris accumulation. In each of the above applications, the DFREF 101 of the solar panel 102 may advantageously help keep these components clear of debris, dust, sand, ice, and snow, etc., ensuring that these systems always function correctly and safely.

In one example embodiment, the disclosed dual-function retrofittable electrodynamic cleaning system (RECS) with a dual-function device for dust and snow removal functionalities can be implemented as a smart photovoltaic module architecture in which a power and control unit (PCU) is embedded within a junction box of the solar panel. The PCU is integrated with panel-level maximum power point tracking (MPPT) functionality and is operatively coupled to nanomaterial electrode networks configured for electrodynamic dust removal and resistive snow or ice removal. The smart module further includes one or more sensors selected from temperature sensors, snow or load sensors, and electrical output sensing elements. In addition to direct sensing, dust and snow accumulation may be detected through power analytics performed by the PCU based on deviations in expected photovoltaic output.

In another example embodiment, the PCU manages both energy optimization and cleaning control, selectively actuating dust-removal or heating modes based on sensed conditions or inferred soiling states. Wireless connectivity may be provided between the PCU and solar-based application or the software module, enabling continuous monitoring of soiling conditions, transmission of operational data, and automated optimization of cleaning schedules based on collected data and historical performance. The solar panel operates as a fully self-sufficient smart solar module with autonomous dual-mode cleaning and heating functionality, with standard electrical interfaces externally and without additional external cleaning hardware or manual intervention.

While the above description provides examples of one or more apparatus, methods, or systems, it will be appreciated that other apparatus, methods, or systems may be within the scope of the claims as interpreted by one of skill in the art.

Although the disclosure has been explained in relation to its preferred embodiment, it is to be understood that many other modifications and variations can be made without departing from the spirit and scope of the invention as hereinafter claimed. The present disclosure may be embodied in other forms without departing from the spirit and the attributes hereof, and, accordingly, reference should be made to the appended claims, rather than to the foregoing specification, as indicative of the scope of the invention.

1. An apparatus for dust removal and snow removal on a solar panel, the solar panel comprising a top surface and a plurality of active photovoltaic elements with intervening inactive regions defined by gaps between cells, bus bars, and finger grid lines of the solar panel, the apparatus comprising:
a dual-function electrodynamic retrofit film (DFERF) comprising a transparent substrate and one or more nanomaterial electrodes (NMEs) disposed on the transparent substrate in one or more layers of the dual-function electrodynamic retrofit film (DFERF);
a plurality of switches operatively connected to a power control unit (PCU), such that the plurality of switches is configured to switch the one or more nanomaterial electrodes (NMEs) from a first functionality for removing dust to a second functionality for removing snow;
a power supply system including one or more power generators, one or more power sources, and a plurality of power supply circuits for providing electricity to the one or more nanomaterial electrodes (NMEs) in the dual-function electrodynamic retrofit film (DFERF),
wherein the power supply system delivers a high-voltage alternating current to the one or more nanomaterial electrodes (NMEs) in the first functionality and a direct current to the one or more nanomaterial electrodes (NMEs) in the second functionality; and
one or more sensors for monitoring conditions of the solar panel and environment for triggering the plurality of switches to switch the one or more nanomaterial electrodes (NMEs) from the first functionality to the second functionality, and from the second functionality to the first functionality,
wherein, in the first functionality, a first subset of the one or more nanomaterial electrodes (NMEs) is activated as electrostatic force generators producing a traveling electric field wave that charges and repels dust particles from the top surface of the solar panel,
wherein, in the second functionality, a second subset of the one or more nanomaterial electrodes (NMEs) is activated as resistive heaters for generating heat to melt accumulated snow on the solar panel,
wherein the one or more nanomaterial electrodes (NMEs) are positioned to align with the inactive regions of the solar panel such that the active photovoltaic elements of the solar panel remain uncovered and unshaded by the one or more nanomaterial electrodes (NMEs).

2. The apparatus of claim 1, wherein the one or more nanomaterial electrodes (NMEs) are disposed in a single layer within the dual-function electrodynamic retrofit film (DFERF), and wherein the one or more nanomaterial electrodes (NMEs) in said single layer serve as part of the first subset and the second subset depending on the first and second functionality selected.

3. The apparatus of claim 1, wherein the first subset of the one or more nanomaterial electrodes (NMEs) is disposed in a first layer of the dual-function electrodynamic retrofit film (DFERF) and the second subset of the one or more nanomaterial electrodes (NMEs) is disposed in a second layer of the dual-function electrodynamic retrofit film (DFERF), the first layer being positioned above the second layer closer to the light receiving surface of the solar panel.

4. The apparatus of claim 1, wherein the dual-function electrodynamic retrofit film (DFERF) is integrated into the solar panel during manufacturing such that at least some of the one or more nanomaterial electrodes (NMEs) are embedded in the layered structure of the solar panel at the inter cell gaps, bus bars, or finger locations, without covering one or more active elements of the solar panel.

5. The apparatus of claim 1, wherein the dual-function electrodynamic retrofit film (DFERF) is configured as a retrofit film applied to an existing solar panel after manufacture, the one or more nanomaterial electrodes (NMEs) being aligned over the inter cell gaps, the bus bars, or the fingers on the top surface so that the one or more NMEs register with non-active regions and avoid covering the one or more active elements of the solar panel.

6. The apparatus of claim 1, wherein the one or more nanomaterial electrodes (NMEs) are formed by printed conductive ink on or within the dual-function electrodynamic retrofit film (DFERF), the conductive ink comprising one or more of silver nanowires, indium tin oxide, or copper nanoparticles, and wherein the dual-function electrodynamic retrofit film (DFERF) comprises a transparent polymer selected from polyethylene terephthalate (PET) or similar photovoltaic-compatible substrates.

7. The apparatus of claim 1, wherein the second subset of the one or more nanomaterial electrodes (NMEs) configured as heaters comprises a pattern of parallel line electrodes disposed in the gaps between solar cells, each line electrode being connected in parallel in a low-voltage, high-current heating circuit.

8. The apparatus of claim 1, wherein the second subset of the one or more nanomaterial electrodes (NMEs) configured as heaters comprises the one or more NMEs in series disposed through multiple gaps of the solar panel, forming a closed-loop or series circuit for high voltage, low-current heating operation.

9. The apparatus of claim 1, further comprising a power control unit (PCU) operatively connected to the plurality of switches and the one or more sensors, the PCU being configured to automatically control the one or more nanomaterial electrodes (NMEs) switch between the first functionality and the second functionality based on signals from the one or more sensors, and autonomously switching the apparatus between dust-removal mode and snow-removal mode.

10. The apparatus of claim 1, wherein the one or more sensors include any one or more of snow weight detectors, temperature sensors, and power output sensors, wherein the power output sensors are configured to detect a sudden drop in power output indicating the accumulation of snow or dust on the solar panel.

11. A method of removing dust and snow from a solar panel having a top surface and a plurality of active photovoltaic elements with intervening inactive regions, the method comprising:
applying to the solar panel a dual-function electrodynamic retrofit film (DFERF) that includes one or more nanomaterial electrodes (NMEs) arranged in one or more layers, and providing a switching mechanism by a plurality of switches operatively connected to a power control unit (PCU) to configure the one or more nanomaterial electrodes (NMEs) for a first functionality and a second functionality;
providing power to the dual-function electrodynamic retrofit film (DFERF) via one or more power supply circuits such that the one or more nanomaterial electrodes (NMEs) can receive a high-voltage alternating current in the first functionality and a direct current in the second functionality;
monitoring conditions of the solar panel and environment using one or more sensors, and triggering a mode switch when predetermined conditions are met;
in response to detecting dust on the solar panel, activating a first subset of the one or more nanomaterial electrodes (NMEs) in the first functionality to generate a traveling electrostatic wave that charges dust particles and repels them off the light receiving surface of the solar panel; and
in response to detecting snow on the panel, activating a second subset of the one or more nanomaterial electrodes (NMEs) in the second functionality to generate heat, thereby melting the snow on the solar panel,
wherein the one or more nanomaterial electrodes (NMEs) are positioned over the one or more inactive regions including gaps, bus bars, fingers of the solar panel without blocking sunlight from the active elements of the solar panel.

12. The method of claim 11, wherein the DFERF film comprises a single layer of electrodes, and wherein at least one of the one or more nanomaterial electrodes (NMEs) in the single layer is used in the first subset for dust removal and in the second subset for snow removal.

13. The method of claim 11, wherein the step of applying the DFERF includes providing a first layer of electrodes as the first subset for dust removal and a second layer of nanomaterial electrodes (NMEs) as the second subset for snow removal, the first layer being disposed above the second layer in an assembled DFERF film.

14. The method of claim 11, wherein the DFERF film is integrated during manufacturing of the solar panel, such that the method includes manufacturing the solar panel with built-in dust-removal and snow-removal electrodes positioned in the layered structure of the solar panel at the inter-cell gaps, the bus bar, or the finger locations.

15. The method of claim 11, wherein the DFERF film is retrofitted to an existing solar panel, the method includes attaching a pre-fabricated transparent film with the one or more nanomaterial electrodes (NMEs) onto the light receiving surface of the solar panel and aligning the one or more nanomaterial electrodes (NMEs) with the inter-cell gaps, the bus bars, or the fingers of the solar panel.

16. The method of claim 11, wherein the one or more nanomaterial electrodes (NMEs) are printed onto the dual-function electrodynamic retrofit film (DFERF) using a conductive ink, and wherein the conductive ink is transparent and comprises one or more conductive nanomaterials selected from silver nanowires, indium tin oxide, and copper, wherein the dual-function electrodynamic retrofit film (DFERF) material being a transparent substrate such as PET.

17. The method of claim 11, wherein the second subset of the one or more nanomaterial electrodes (NMEs) is configured as parallel line heaters disposed in the gaps of the solar panel, and the method includes supplying a low-voltage, higher-current DC power such that each line heater melts snow in its respective region in parallel.

18. The method of claim 11, wherein the second subset of the one or more nanomaterial electrodes (NMEs) is configured as a single continuous heater line in series looping through multiple panel regions, and the method includes supplying a higher-voltage, lower-current DC power through said continuous heater line to generate heat for snow melting.

19. The method of claim 11, wherein switching the one or more nanomaterial electrodes (NMEs) between the first and second functionality by a power control unit (PCU) such that the PCU automatically selects a dust removal mode and a snow removal mode based on one or more monitored conditions, the PCU sending control signals to the switches to connect the one or more nanomaterial electrodes (NMEs) network once the sensors detect a threshold level of dust or snow.
